(19) United States
(12) Patent Application Publication
(10) Pub. No.: US 2011/0148798 A1
(43) Pub. Date: Jun. 23, 2011

(54) OBJECT LOCATION

(75) Inventor: Tobias Dahl, Oslo (NO)

(73) Assignee: ELLIPTIC LABORATORIES AS, Oslo (NO)

(21) Appl. No.: 12/996,608

(22) PCT Filed: Jun. 4, 2009
(86) PCT No.: PCT/GB09/01402

§ 371 Date: Feb. 25, 2011

(30) Foreign Application Priority Data
Jun. 4, 2008 (GB) 0810179.2

(51) Int. Cl. G06F 3/041

(52) U.S. Cl. 345/173

(57) ABSTRACT

An apparatus determines the position of a target part of a user's hand within a predetermined zone. It has a plurality of transducers for transmitting and/or receiving locating signals. The transducers are arranged such that, for any location of the target hand part within the predetermined zone there are at least two pairings of transmitting transducers and receiving transducers for which the total time-of-flight of said timing signals from the transmitter of the pairing to the receiver of the pairing via the target part of the user's hand is less than equivalent total times-of-flight to and from a set of points comprising all points in the predetermined zone which are beyond a minimum spacing from the target hand part but at least as far away from the nearest point of the apparatus as the location of the target hand part is. In some embodiments a selection is made between possible channels to determine which can be used for tracking without suffering from finger/hand confusion.

This invention relates to apparatus and methods for determining the location of an object, particularly although not exclusively using acoustic waves reflected from the object.

Touch- or proximity-based computer display screens, in which movement of a stylus or a fingertip in contact with, or close to, a screen is used to control a computing device, are well known. Typically various types of pressure, electrostatic or optical sensors are used to detect the location of the stylus or finger in contact with the screen surface.

IBM Technical Disclosure Bulletin Vol. 27, No. 11, April 1985 entitled “Ultrasonic Cursor Position Detection” mentions finger tracking but advocates an ultrasonic stylus position-detection and cursor control system for a display surface. Systems have also been proposed in which a user is required to wear or hold active electronic elements. Any such arrangements requiring a user to wear or hold an object are, however, necessarily somewhat fiddly and inconvenient.

Arrangements have also been proposed that use acoustic impulses or waves above the surface of the display to determine the location of a simple passive stylus or fingertip by bouncing the sound off the pointing device and timing the sound's journey from transmitter to receiver. Such systems can be arranged to detect a pointing device in contact with the screen (touch-screen mode) but may also be used to detect a pointer that is proximate but not in contact with the screen surface (proximity mode).

Other finger-input tracking systems have been described that do not track input directly adjacent a display screen. For example, a finger input control system is disclosed in U.S. Pat. No. 6,313,825 assigned to Gateway, Inc in which movement of a finger in a region beside a keyboard can be used to control a cursor on a screen remote from the region. Another finger input system is described in U.S. Pat. No. 5,059,959 assigned to Seven Oaks Corporation in which the mapping between the field in which the finger may move and the screen is said not to be scaled one-to-one.

However the applicant has recognised that whilst echo-based fingertip tracking systems are far more convenient than those requiring a stylus or other accessory, particularly where the tracking zone is larger than about hand size (so that a fingertip can give relatively fine control), they suffer from a significant shortcoming, namely that they are prone to inaccuracy arising from other parts of a user's hand being mistaken for the fingertip which would tend to result in an erroneous input to the device being controlled.

The Applicant has further appreciated that this problem increases significantly as the tracking zone increases in size; it is, for example, highly relevant for tracking zones that are larger than a typical hand.

It is an aim of the present invention, in at least some aspects, to address this problem.

When viewed from a first aspect the invention provides an apparatus for determining the position of a target part of a user's hand within a predetermined zone, the apparatus comprising a plurality of transducers for transmitting and/or receiving locating signals; wherein the transducers are arranged such that, for any location of the target hand part within the predetermined zone there are at least two pairings of transmitting transducers and receiving transducers for which the total time-of-flight of said locating signals from the transmitter of the pairing to the receiver of the pairing via the target part of the user's hand is less than the equivalent total times-of-flight to and from a set of points, wherein said set of points comprises all points in the predetermined zone which are beyond a minimum spacing from the target hand part but at least as far away from the nearest point of the apparatus, e.g. a screen or other surface, as the location of the target hand part is.

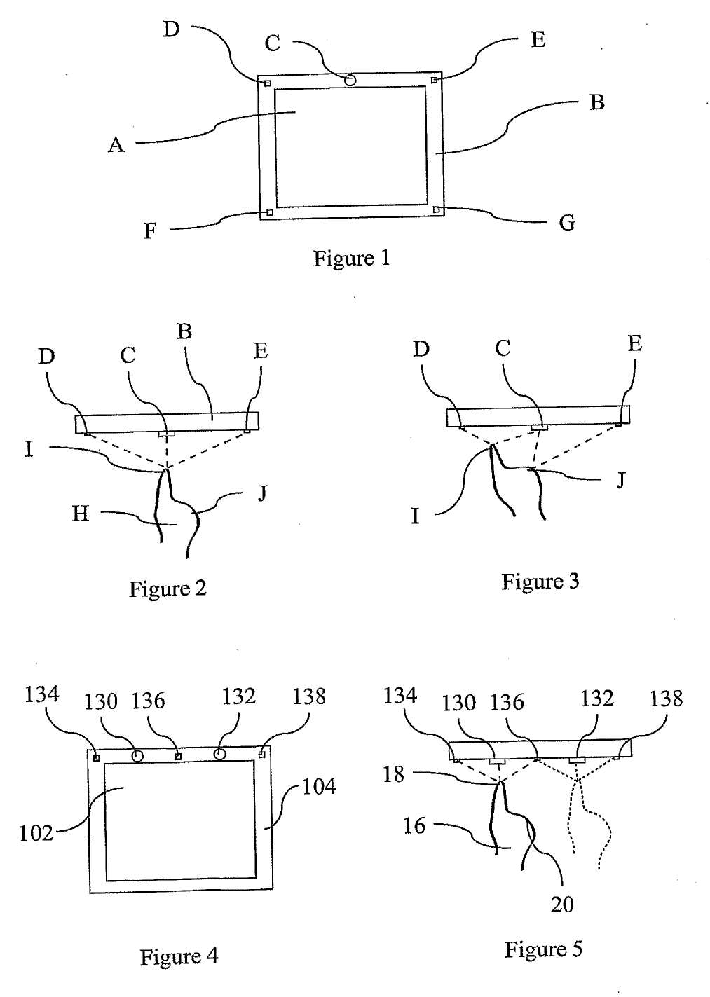

The Applicant's primary realisation is that in prior art fingertip location/tracking systems, the layout of the transmitters and receivers could give rise to a situation where for some transmitter/receiver pairings a part of the hand other than the fingertip would be detected as closest or overlapping, even though the fingertip was in fact the foremost part of the hand in relation to the apparatus—e.g. the screen or other surface. This is illustrated by the example shown in FIGS. 1 to 3.

FIG. 1 shows a front projection of a finger-input tracking system exhibiting the problem described above. The apparatus has a rectangular flat-panel LCD screen A, for displaying a graphical user interface, bordered by a frame B. Mounted in the frame are an ultrasound transmitter C and four ultrasound receivers D, E, F, G one in each corner of the frame B.

FIG. 2 shows a user interacting with the system of FIG. 1 through the positioning of the user's hand H. The system is intended to track the tip I of the user's extended index finger, in order to activate, select or otherwise control user interface elements, such as tick-boxes, cursors or pointers. When the user's fingertip I is positioned on or near the vertical centreline of the screen A, the system is able to determine the position of the fingertip I using ultrasonic time-of-flight information obtained in respect of each of the four receivers D, E, F, G. Some of an ultrasonic impulse emitted by the transmitter C travels directly to the fingertip I, as indicated by the dashed line. It is then reflected by the fingertip and a portion of the echo is received at each of the receivers D, E, F, G as indicated by the dashed lines. Here only the top-left and top-right receivers D, E are ‘visible’. Using information relating to the total time of flight of the impulse from the transmitter C via the fingertip I and back to each receiver, and knowledge of the speed of sound in air, it is possible to determine the location of the fingertip in space by well-known methods of ellipse intersection.

FIG. 3 shows the user interacting with the same system. However, in this instance, due to the user's fingertip I being further towards the left side of the screen A, the system would be unable to determine the correct location of the fingertip. This is because, although for top-left and bottom-left (not shown in FIG. 3) receivers D, F the fingertip is the closest reflective object to the transmitter and the receivers by way of time of flight from the transmitter to the receiver, this is no longer the situation for the top-right and bottom-right (not shown in FIG. 3) receivers E, G: the knuckle J of the user's little finger is closer, by way of total time-of-flight, to these two receivers than is the user's index fingertip I. The first echo received, therefore, would be from the little-finger knuckle J rather than the index fingertip I. The system cannot however determine that the receivers on the right are not correctly receiving echoes from the fingertip I and would therefore either produce an inaccurate position determination; or be unable to reconcile the timings in respect of the four receivers D, E, F, G and therefore return an error.

In accordance with the invention however, the arrangement of transducers means that they can collectively distinguish the actual closest part of the hand from any other part of the hand (separated from the closest part by the minimum spacing) that might be closer to one of the transducers or one pairing of the transducers. Such arrangements mean that wherever the fingertip may be within the active region, there will be at least two transmitter/receiver pairs that have an unimpeded ‘line of sight’ to the fingertip so as to be able to discriminate between the target fingertip and any other object. This allows the time-of-flight information from these two pairings to be used to locate the fingertip, at least in two dimensions. Of course more transducers could be used so that there were more pairings meeting the criterion set out above. This could allow, for example, three dimensional location. It will be clear from the description below, that the term ‘line-of-sight’, when used in this context, is different from what is understood in e.g. automated robot inspection or video tracking systems as the ‘occlusion problem’. The ‘line of sight’ problem described in this application, is specific and inherent to ranging systems, having low or no angular resolution. A camera on the other hand, has excellent angular resolution. The ‘line-of-sight’ problem arising in the context of range-based human digit tracking comes, if anything, in addition to the more traditional ‘line-of-sight’ problems, which are common, regardless of the sensor type used.

When viewed from another aspect the invention provides an apparatus for determining the position of a target part of a user's hand within a predetermined zone, the apparatus comprising a plurality of transducers for transmitting and/or receiving locating signals; wherein the transducers are arranged such that, whenever the target hand part is the closest part of the hand to an edge of the zone, for at least one transmitter-receiver pair, the maximum time of flight of a locating signal transmitted by the transmitter, reflected by said target part of the hand and received by the receiver is shorter by at least a threshold time than the minimum time of flight of a locating signal reflected by parts of the hand which are more than a predetermined distance away from the target part of the hand.

In some preferred embodiments, e.g. those using a single impulse response sample to make the measurement, said threshold time is equal to one over the bandwidth of the system multiplied by the sampling frequency of the system, where the bandwidth is defined as the proportion of the available spectrum used in the output and input signals. If, for instance a band-pass filter with frequency response from 0 to 24 kHz was applied to a signal with frequency response from 0 to 48 kHz, then the bandwidth would be 0.5. If all frequencies were retained, the bandwidth would be defined as 1.

The target object could be anything which has a sufficiently well-defined part for tracking and which can be moved sufficiently finely to exercise the desired control. It could for example comprise a stylus or other artificial object. However it is a strength of at least preferred embodiments that no such artificial object is required and that a simple extended digit—e.g. thumb or index finger can be tracked.

The specified minimum spacing is chosen on the basis of the dimensions of the hand or other object being used for pointing and in particular the distance between the part to be tracked—e.g. fingertip—and any other part of the object which might have confused the system in prior art arrangements—e.g. a knuckle. It can be thought of crudely as the ‘shape resolution’ of the transducer layout (as opposed to the intrinsic locating resolution). Preferably the specified minimum spacing is less than 2 cm, preferably less than 1 cm. Preferably it is more than 1 mm, preferably more than 5 mm.

The two transducer pairings may both comprise separate transmitters and receivers. However, either the transmitter or the receiver could be shared between them. As the number of pairings increase, so do the possibilities for the sharing of transmitters and/or receivers between them.

A transmitter may be a distinct from a receiver or may comprise the same physical components which are arranged to emit and receive energy respectively.

The system could employ optical or other electromagnetic signals and transducers. In a set of preferred embodiments the transducers are acoustic, preferably ultrasonic transducers. Ultrasonic signals have frequencies greater than 20 kHz, preferably greater than 30 kHz. In some embodiments the frequency might be in the range 35-45 kHz. In other embodiments a higher frequency is better. Thus in another set of embodiments the frequency is greater than 50 Hz or even greater than 100 kHz—e.g. between 100 and 200 kHz. The transmitters could be controlled to transmit continuous signals or discrete impulses. The signal may comprise a single frequency, or may comprise a plurality of frequencies.

The apparatus could comprise means, such as a suitably programmed processor for measuring and calculating times of flight. Alternatively it may provide a data output (either wired or wireless) to allow another processor—e.g. in a PC—to carry out such calculations. The timing means are preferably connected to a processing means operable to determine information relating to the time of flight of the signal for each pairing.

The Applicant has recognised that by careful placement of transmitters and receivers in accordance with the invention, the problem of ambiguity between a finger and hand (or similar problems) can be resolved even with relatively few transmitters and receivers. This is presently considered beneficial since providing a large number of transmitters and/or receivers would make the apparatus expensive, which is a critical factor in many consumer electronic devices. In particular, although the, microphones may be comparatively inexpensive, it is difficult to implement the system on a standard, low-cost processor, such as an ARM processor, if the number of input (receiver) channels, and hence the number of analogue-to-digital (A/D) converters required is large. Implementing such a multi-channel systems might need a more expensive FPGA-like solution.

However the Applicant recognises that this may be less significant in some applications either now or in the future and thus the use of a small number of transducers is not essential.

The system could be arranged to calculate time of flight information for all echoes received at all receivers. Alternatively it could be arranged to perform such calculations only on some of the reflected signals received. This might be most relevant particularly, although not necessarily, where the apparatus has a larger number of transmitters and receivers, For example the system could be arranged to define subsets of the predetermined zone and only to treat receivers and/or transmitters associated with the sub-zone in which the target object is located. In preferred embodiments of all aspects of the invention the apparatus or system is arranged to select one or more transmitter-receiver pairs to use for positional measurements. In other words, in some embodiments the apparatus comprises more transmitter-receiver pairs, i.e. more channels, than are needed for tracking. Only some of the channels are used for tracking or positioning of the object. This allows only those that will give the best results to be used.

The decision as to which transmitter-receiver pairs/channels to use could, for example, be based on a knowledge of the approximate position of the object e.g. derived from earlier calculated positions and speed and direction of movement, or indeed any other algorithm. In some preferred embodiments however the results are obtained for each pair/channel, compared and the best chosen. In a set of embodiments the apparatus is configured to determine whether a channel provides a predetermined distinction between a target part of a user's hand and the rest of the hand. In some embodiments for example the apparatus calculates impulse responses from each transmitter-receiver pair and decides which to use on the basis of which impulse response(s) give(s) the best, or a threshold, separation between the impulse response corresponding to the target part of the hand and the impulse response corresponding to the rest of the hand.

When viewed from a further aspect the invention provides an apparatus for tracking movement of an object comprising a plurality of transducers defining between them a plurality of channels, each comprising a transmitter and a receiver, and processing means for selecting a subset of said channels for calculating said movement. Tracking can be carried out by measuring the time of flight of a signal travelling from the transmitter and being reflected from the object to the receiver.

As above, the selection can be made in any appropriate way. In a set of embodiments the apparatus is configured to determine whether a channel provides a predetermined distinction between said object and an interfering reflector. In some preferred embodiments the apparatus is arranged to calculate impulse responses for at least some of the channels and said selection is based on the extent to which a part of the impulse response for a given channel corresponding to said object can be distinguished from the rest of the impulse response for that channel. Of course a mix of selection techniques could be used.

In a set of embodiments of any of the foregoing aspects of the inventions a channel is selected for tracking if the total time-of-flight of signals from the transmitter of the channel to the receiver of the channel via the object is less than the equivalent total times-of-flight to and from a set of points, wherein said set of points comprises all points in a predetermined zone and which are beyond a minimum spacing from the object but at least as far away from the nearest point of the apparatus, e.g. a screen or other surface, as the object is.

Where channels are selectively used for tracking a target hand part, instead of crudely tracking an entire hand, in a set of preferred embodiments the system comprises means for recognizing which channels have a good finger/hand separation by inspecting the received impulse response of the respective channels. If there are two peaks or signal fronts which can be associated respectively with the finger and another part of the hand, the system can decide that the particular channel of this impulse response is ‘clear’ i.e. unobstructed.

When viewed from another aspect the invention provides apparatus for detecting the movement of an object comprising a transmitter for transmitting a signal to said object and a receiver for receiving a reflection of said signal from said object, said transmitter and receiver together defining a channel, the apparatus further comprising means for calculating an impulse response from said receiver and means for identifying two distinct peaks or signal fronts of said impulse response corresponding to said object and another reflector respectively and, if said identification is made, indicating that said channel has an unobstructed view of the object.

In a set of preferred embodiments the apparatus is configured to determine that a particular channel is associated with a transmitter-receiver pair for which the proximity criterion for the target hand part set out in accordance with the first aspect of the invention is satisfied. In other words the apparatus determines whether a given channel is “clear”, i.e. not hampered by TOF overlap between the target hand part that is being tracked and other nearby reflective objects such as the rest of the hand. This is useful in selecting which channels to use for tracking for example.

At least two clear channels are required for tracking, more typically three. In some embodiments the apparatus comprises means for providing feedback to a user that a predetermined number of channels are “clear”, e.g. meet a predetermined criterion for distinguishing a target hand part or other object from the rest of the hand or other potentially interfering reflector, or satisfy the proximity criterion for the target part of the hand Such feedback may be visual; e.g. by changing the shape or size of a cursor or icon on a display screen, or audible, It may indicate to the user that the system is ready or able to detect or track the position of a finger. When the predetermined number of channels are not ‘clear’ the apparatus may be configured to give an error, simply not operate, or could change to another mode—e.g. system may be arranged to track less accurately; for example tracking crude gestural motions of the whole hand.

Such arrangements are novel and inventive in their own right and so from another aspect, the invention provides an apparatus for determining the position of a target part of a user's hand comprising: a plurality of transmitter-receiver pairs, means for determining which of said transmitter-receiver pairs is able to meet a predetermined criterion for determining a distance to the target part, and means for providing feedback to the user that the apparatus is capable of tracking the target part depending upon the number of transmitter-receiver pairs meeting said criterion.

As mentioned above the Applicant has appreciated that having more receivers whilst of benefit in reducing the problem of finger-hand confusion, gives rise to greater costs particularly in terms of the need of analogue-to-digital conversion.

In a set of embodiments the apparatus comprises a plurality of receivers and at least one analogue-to-digital converter arranged such that it can selectively receive signals from two or more of said receivers. This allows the apparatus to have fewer analogue-to-digital converters than receivers, as the receivers can share the analogue-to-digital converter(s), the converter(s) only being used to convert the signals received by a given receiver when necessary. In one example the output from one of a set of several receivers (for example eight receivers) is switchably coupled to one of the available on-chip or off-chip A/D input channels (of which there may, for example, be four in total).

When viewed from another aspect the invention provides an apparatus for tracking the movement of an object comprising at least one transmitter for transmitting a signal to said object and a plurality of receivers for receiving said signal after it has been reflected from said object, the apparatus further comprising at least one analogue-to-digital converter arranged such that it can selectively receive signals from two or more of said receivers.

The sharing of A/D converters can be accomplished in a number of ways. One is by rotating the different receivers' output onto the A/D inputs according to a fixed schedule. In the example above of eight receivers and four converters, receivers 1-4 could be coupled to first to the four A/D converters followed by receivers 5-8; or the routing could be changed gradually, for example, first connecting receivers 1,2,3,4, then 2,3,4,5 etc. This will have the effect of decreasing the temporal update rate for each receiver, but means that the target hand part is observed from a larger number of viewpoints.

Another approach is to route the receiver outputs to the A/D input(s) adaptively, e.g. based on previous position estimates of the target hand part. For instance, it can be seen that if a finger has successfully been located in the upper left corner of a tracking zone, and movement towards the centre of the zone has been determined, then receivers say 1,2 and 3 used in the previous stages of the tracking, which might have had a good view of the upper left corner would have to be replaced by microphones 2,3 and 7 say which are the ones with the best view of the centre.

The above approach for sharing scarce A/D converters between receivers is of course also similarly valid on the transmitter side, i.e. by having several transmitters operating in synchronicity or in sequence, and having the output of the digital-to-analogue (D/A) converters selectively and/or adaptively coupled to the transmitters.

In preferred embodiments of the invention the system is used to track the movements of the hand part or other object. In one set of embodiments the tracked movement is used to control the movement of a selection means on a display screen. The predetermined zone in which movements are tracked could be separate from the display—e.g. in the form similar to a touch-pad, tablet or the like. In a set of preferred embodiments however the predetermined zone includes at least part and preferably all of the area of a display screen. This allows the embodiments of the invention to emulate touch screens without the disadvantages associated with conventional touch screens. Indeed it would allow functionality similar to that provided by a touch-screen without having to alter the actual display at all—so that it could be easily incorporated into existing products incorporating display screens. In a set of advantageous embodiments the active region extends beyond at least one edge of the display screen. This is particularly useful for mobile devices which have small screens as it allows a user to interact with the device more easily without having to increase its physical size.

In some embodiments, e.g. the touch-screen emulator or touch-pad examples given above, the system is arranged to track the object in two dimensions. In other embodiments however, three-dimensional tracking could be carried out, having at least three transmitter/receiver pairings meeting the criterion of the invention. This could be more useful e.g. for controlling a computer game.

Where the predetermined zone comprises part of a display screen or other physical surface this can be considered to be a control surface. This should be understood as a surface in front of which movements can be recognised or tracked; it is not necessary for the surface actually to be touched (although not excluded). More typically the movements will be carried out close to the surface but without touching it. In a set of preferred embodiments an apparatus in accordance with the invention comprises a control surface having at least four transducers arranged around the periphery, said transducers comprising at least one transmitter and at least one receiver, thereby defining at least three transmitter receiver pairings, wherein said transducers are arranged such that the separation between the respective transmitter and receiver of each pairing is at least a quarter of the length of the shortest side of the control surface.

By thus ensuring a minimum spacing between the transmitter and receiver of each channel, the condition specified in accordance with the first aspect of the invention can be met namely that there will be at least two pairings of transmitting transducers and receiving transducers for which the total time-of-flight of said locating signals from the transmitter of the pairing to the receiver of the pairing via the target part of the user's hand is less than the equivalent total times-of-flight to and from a set of points, wherein said set of points comprises all points in the predetermined zone which are beyond a minimum spacing from the target hand part but at least as far away from the nearest point of the control surface as the target hand part is.

The invention extends to an apparatus for tracking an object comprising a control surface having at least four transducers arranged around the periphery, said transducers comprising at least one transmitter and at least one receiver, thereby defining at least three transmitter receiver pairings, wherein said transducers are arranged such that the separation between the respective transmitter and receiver of each pairing is at least a quarter of the length of the shortest side of the control surface.

This arrangement is particularly applicable where said shortest side is at least 5 cm, e.g. more than 7 cm, more than 10 cm, more than 15 cm or more than 20 cm.

The separation between the respective transmitter and receiver of each pairing could be at least half the length, or at least the whole length, or greater than the length of the shortest side of the control surface. The control surface could be rectangular, square or any other shape. For example the control surface could be circular or elliptic, wherein reference to the shortest side should be read as the diameter or minor axis respectively.

Preferably the transducers comprise one transducer of one type (transmitter or receiver) and three transducers of the opposite type.

The transducers could all be along one side of the screen, i.e. none of the transmitter-receiver pairings spans part of the control surface. However in other embodiments, the transducers are not all on the same side. In this case the Applicant has discovered that the transducers which are on the same side should not be too close together. More specifically there should be at least two transducers of the same type (i.e. two transmitter or two receivers) separated by at least half a wavelength of the minimum frequency signal the transmitter is arranged to transmit. The separation could be more than full wavelength or more than two wavelengths. This makes it clear that the transducers do not form an array as that term is understood in the art. Preferably the two transducers are separated by at least an amount equal to 10% of the length of the shortest sides of the control surface, e.g. more than 20%, e.g. more than 30%. It will be seen then, that what is actually established, is a ‘near-field’ tracking situation. The transducers are sufficiently well spaced to be able to determine the position of an object along the working surface, purely by using relative timing differences. This is impossible unless there is a sufficient base-line in the transducer system. Whereas the planar position can be established using only relative timing differences, the vertical position offset is established by using the absolute timings of the signal, and the two are combined two produce a 3D position.

In preferred embodiments of the apparatus set out above the channels defined by the transmitter-receiver pairings are all used to track the object.

The signal, and thus the transducers, may be optical but are preferably acoustic, more preferably ultrasonic. The applicant has realised that acoustic systems are beneficial for location and tracking since the signals can spread to give coverage over a wide area rather than being restricted to a narrow field of view as an optically-based system would be. This is particularly valuable as it is compatible with strict modern screen design requirements in both mobile and static devices which call for completely flat surfaces. Nonetheless transducers will typically not have a uniform angular transmission/reception pattern. In preferred embodiments therefore an inverting filter is applied to the signal to be transmitted by a transmitter or the signal received by a receiver, said inverting filter compensating for the directional pattern of said transmitter or receiver.

This is believed to be novel method for separating objects in touchless tracking applications from interfering objects, and thus from a further aspect the invention provides a method of tracking the movement of an object within a predetermined zone comprising transmitting an acoustic signal from a transmitter, receiving said signal at a receiver after it has been reflected from the object and applying an inverting filter to the signal prior to transmission by the transmitter and/or after reception by the receiver to compensate for directional variation in the performance of said transmitter and/or receiver.

In some preferred embodiments the frequency spectrum of the transmitted signal is modified to enhance or suppress frequencies corresponding to propagation directions which it is desired to enhance or suppress. For example this would mean that prior knowledge of where possible objects are believed to be located could be taken into account, by modifying the transmitted signals to contain strong frequency components in the directions of propagation where objects are expected to be; or conversely, by emitting signals with few or no frequency components in directions where an ‘interfering’ object is expected to be.

The inverting filters can equally well be derived in the frequency domain, with various weighting of various frequencies, or they could be implemented in the time domain as matrix inverses of a general form, i.e. not necessarily Toeplitz matrices, serving the purpose of ‘unmapping’ the filtering of the echoes in the various direction. Filtering could also be carried out on the envelopes of the signals, or even on the envelopes of successive frequency bands. Particularly; if the objects have similar or equal reflective capacity in some frequency sub-bands, this could be used to increased the cross-range resolution of the system. The inverse filters need also not be linear, nor do they have to be computed by linear means. For instance, they could be computed adaptively using neural nets or genetic algorithms, involving learning functions maximizing separation and/or information content using information-theoretical approaches and entropy measures. Finally, filtering could be carried out both on the transmitter and the receiver side simultaneously, and could even involve an inverse filtering step of the reflecting object itself, making for instance an object tilted at an angle, thereby introducing a non-linear phase delay to the signal, appear sharper than it otherwise would. As a by-product, the orientation of the object could be calculated.

The applicant has appreciated that the directional characteristics of the transducers is in fact a positive feature as it allows more accurate tracking of an object by being able to take account of the direction of the signal either before or after it is reflected from the object. Indeed in some embodiments the directivity is deliberately enhanced. In one set of embodiments at least one of the transducers or its housing is configured to enhance the directivity of the transducer. This will, for example, give a lesser degree of angular symmetry than would be achieved by an unmodified and unhoused circular transducer. In one set of embodiments the transducer referred to above is made larger than a standard transducer and/or non-circular in order to enhance the directivity.

In another set of embodiments a scattering structure is provided in the path of the signal or reflection to add directivity. There are a variety of different structures that could be used for the scattering structure. Some non-limiting examples include a panel with an irregular array of apertures, a series of irregular projections or tubes, or one or more irregular passages through a body, a series of regular projection or tubes leading to a irregular pattern of outlets, or a series of irregular projections or tubes leading to an irregular pattern of outlets.

When viewed from another aspect the invention provides a method of determining a bearing to an object comprising:
transmitting a signal towards said object;
receiving a reflection of said signal from said object;
digitally analysing the received signal to determine a bearing to said object;
   wherein:
the transmitted or reflected signal passes through a scattering structure arranged to modify the signal or reflection as a function of propagation direction.

This aspect of the invention extends to apparatus for determining a bearing to an object comprising:
a transmitter for transmitting a signal towards said object;
a receiver for receiving a reflection of said signal from said object;
a scattering structure arranged such that the transmitted or reflected signal passes through it and configured in use to modify the signal or reflection as a function of propagation direction; and
means for digitally analysing the received signal to determine a bearing to said object.

Preferably the modification affects at least one of the amplitude, frequency or phase of the impulse; it may, of course, affect several of these. Preferably the signal is an acoustic, preferably ultrasonic signal.

Advantageously the function takes unique values for each of a plurality of directions irregularly distributed and/or angled in space. The step of analysing the received signal to determine a bearing preferably comprises applying an inverse of the function to the received reflection. Thus it is possible to obtain information relating to the location of an object by employing knowledge of the directional nature of the emitted impulse. This information may be used to reduce the amount of information that would otherwise be required from time-of-flight determinations in order to determine accurately the location of the object.

The function may be determined by modelling; alternatively it may be determined empirically in a training phase. It could also be determined ‘blindly’ i.e. without prior training, by optimizing one or most cost functions relating to the overall visibility and/or separability of the resulting processed signal recordings.

In one set of possible embodiments the scattering structure comprises a plurality of apertures. Preferably the diameters of the apertures are less than 1 cm; more preferably less than 1 mm. Ultrasound at 40 kHz has a wavelength of approximately 8 mm in air and the holes are therefore relatively small compared to the wavelength of low-frequency ultrasound. Preferably the apertures individually act, in use, as point source emitters of sound, although in combination they will not.

In another set of embodiments the scattering structure comprises a plurality of elongate projections into the signal path of the transducer. The two aforementioned sets of embodiments are not mutually exclusive; the projections could comprise apertures—e.g. along their length or simply at the mouths of hollow tubes.

In another set of embodiments the scattering structure comprises a plurality of channels, the structure being located in the signal path of the transducer such that substantially all of the signal to or from the transducer passes through the channels of the structure. Preferably for at least one frequency the channels have different signal path lengths measured from the transducer to an opening of each channel. The channels could be cylindrical or non-cylindrical.

The scattering structure may be applied to just one transducer or to a plurality. Where it is applied to a plurality this could be a transmitter and receiver, or a multiple of each or both. Clearly the plural scattering structures could be the same or they could be different. In preferred embodiments which have plural scattering structures, their directional patterns are combined to give an composite pattern which will typically be more complex, and thus more discerning of propagation direction, than the individual patterns. A single composite inverse function could be computed, either empirically or from the functions or inverses of the scattering structures.

In a particularly advantageous set of embodiments of the inventions set out above, the scattering structure comprises the housing of an electronic device—e.g. to allow movement of the object being tracked, such as a finger, to control the device. This can allow a transducer to be embedded in the device with only one or more inconspicuous apertures being visible. This opens up the possibility of an almost invisible (to the user) integration of touchless functionality in an existing design of device.

This is novel and inventive in its own right and thus when viewed from another aspect the invention provides apparatus for determining a bearing to an object comprising:
a device body;
a transmitter for transmitting a signal towards said object and a receiver for receiving a reflection of said signal from said object, wherein at least one of said transmitter and said receiver is inside said device body;
a scattering structure comprising an aperture in the device body communicating with said transmitter or receiver in the device body such that the transmitted or reflected signal passes through said structure so as in use to modify the signal or reflection as a function of propagation direction; and
means for digitally analysing the received signal to determine a bearing to said object.

Preferably the or each aperture comprises a plurality of protrusions inside it and/or is non-cylindrical.

The Applicant has envisaged further advantageous embodiments of this aspect of the invention and other aspects of the invention in which a transducer is embedded inside a device and communicates via an aperture in the body of the device. In such embodiments a plurality of apertures is provided so that a plurality of distinct tracking zones is defined in use. For example in a cell phone or PDA, one aperture or set of apertures e.g. at the front could be used for tracking within a zone in front of the device that could be used for operating the device while it is being held; whereas a second aperture or set of apertures was provided—e.g., on the side, to define a second tracking zone—e.g. for when the device is on a desk (the zone being at the surface of the desk. In this way a touchless-enabled phone could turn any surface into a virtual keyboard or cursor control pad.

This concept too is novel and inventive in its own right, even if other scattering structures are used, and thus when viewed from another aspect the invention provides apparatus for tracking movement of an object comprising:
a transmitter for transmitting a signal towards said object and a receiver for receiving a reflection of said signal from said object;
a first scattering structure arranged such that the transmitted or reflected signal passes through said structure to or from a first tracking zone so as in use to modify the signal or reflection as a function of propagation direction
a second scattering structure arranged such that the transmitted or reflected signal passes through said structure to or from a second tracking zone so as in use to modify the signal or reflection as a function of propagation direction; and
means for digitally analysing the received signal to determine a position of and/or a bearing to said object.

Although separate scattering structures are used, such as apertures in the device body in the earlier example, this does not mean that separate transducers are required for each tracking zone. This beneficially reduces the complexity, weight and cost of such a device.

More generally in accordance with any aspect of the invention, although there may only be a single predetermined zone/tracking zone or control surface, a plurality could be provided. These may be similar to one another—e.g. two zones for finger tracking on both of a user's hands, but the Applicant has devised a further beneficial arrangement whereby one zone is used for tracking as set out hereinabove and one zone is used to detect another movement. The other movement is typically one which is more restricted and thus easier to detect reliably. This might be particularly useful for the mobile-phone table-based operation described above, since one hand could then be used for finger tracking, while the other could be used to carry out a simple motion, such as a repetitive motion that could indicate a “click” or a jitter. This avoids the problem of both having to detect a finger tracing motion and vertical finger movements with the same set-up which may have poor resolution in the out-of-plane direction. Thus in a set of embodiments the apparatus further comprises at least one additional channel arranged to determine a more limited set of movements in a second predetermined zone. The second zone could overlap the first but is preferably distinct from it.

This is novel and inventive in its own right and thus when viewed from a further aspect the invention provides an apparatus comprising a plurality of transmitters and receivers arranged so as to define first and second simultaneously operable zones in which movements of respective target objects can be detected such that a more limited set of movements can be detected in the second zone as compared to the first. As above, one zone could be used for tracking and the other for gesture recognition such as a ‘click’, tap or jitter.

In accordance with certain aspects of the invention described earlier, the layout of the transducers is chosen carefully to avoid misinterpretation of the wrong parts of a pointing object, e.g. a hand, as the pointing tip. As the number of transducers increases, the easier this is to achieve. The applicant has realised that by extrapolating this one gets to a linear array of transducers along one edge of the tracking zone. The applicant has further realised that such an array could be replaced, with no significant complication, by a single elongate transducer. Furthermore an elongate transducer is beneficial when used with acoustic waves since it gives a more complex directional pattern (and hence better directional discretion) than a point transducer. In addition, having an elongated transducer is beneficial in increasing the likelihood that the tip of the finger is closer to at least part of it. An elongate transmitter is particularly advantageous since the Applicant has appreciated that an elongate transmitter would be easier to manufacture than a smaller, point source one; moreover it allows more power to be transmitted and so gives an improved signal-to-noise ratio. Moreover, an elongate transmitter may be advantageous in a noisy environment (e.g. one in which two or more devices embodying the present invention are located in proximity of each other), since it can produce a more directional sound than a point source would, thereby decreasing the likelihood of cross-talk.

When viewed from a further aspect, the invention provides an apparatus for determining the location of an object comprising an elongate transmitter, at least one receiver and processing means in communication with said transmitter and operable to determine the location of an object at least within a zone defined partly by the projection of the transmitter normal to its length.

The invention extends to a method of determining the location of an object comprising transmitting a signal from an elongate transmitter, receiving the signal after reflection from the object using a receiver and determining the location of said object at least within a zone defined partly by the projection of the transmitter normal to its length.

Thus, an elongate transmitter, is used to locate an object in a region defined in front of it. Preferably the apparatus is arranged to determine the location of the object based on a time-of-flight for signals transmitted by the elongate transmitter, reflected by the object and received at the receiver. In preferred embodiments the apparatus is arranged to track movements of said object within said zone.

In some preferred embodiments the elongate transducer is arranged to lie parallel with an edge of planar surface such as a touch-pad or more preferably a display screen, to allow control of the movement of an on-screen selection means. In preferred embodiments the transmitter is completely flush or recessed relative to the planar surface.

The transmitter may be curved but is preferably linear along its elongate axis; in the latter instance, computations are simplified as the shortest path between an object within the zone and the elongate transmitter is perpendicular to the transmitter.

When applied to a finger-based touch-screen emulator or similar proximity interface system using signal time-of-flight information, the use of an elongate transmitter can reduce the likelihood of a part of a user's hand other than the intended fingertip being responsible for the first-received reflection at a receiver since, at least in respect of the fraction of the signal path between the fingertip and the elongate transmitter, the fingertip only needs to be the closest part of the user's hand at some point along the length of the elongate transmitter.

In some embodiments a second elongate transducer is also provided. This could be the recited receiver or it could be a third transducer (transmitter or receiver). The two elongate transducers may be located parallel to one another or at any other angle but are preferably substantially perpendicular to one another. In some preferred embodiments, one elongate transducer is situated adjacent the top or bottom edge of a display screen while a second is situated adjacent the left or right edge.

As used herein the term “elongate transducer” is intended to mean a transducer in which the active element (that which transmits or receives signals) is significantly longer in one of its dimensions orthogonal to the central transmission/reception axis, than the other such orthogonal dimension. For example in preferred embodiments the length of the transducer is at least twice its width, more preferably more than five times its width and more preferably more than ten times its width.

As explained above, the shortest distance between an object in a tracking zone field and a linear, elongate transducer is a perpendicular line, which means that the use of such a transducer in a touch-screen emulator can simplify the geometric calculation required for determining the location of the object and thus the processing power required. It can dispense with the need for at least some ellipse-based calculations when determining the coordinate of a point using time-of-flight methods.

Of course, with respect to helping the separation between finger and hand through careful transducer configurations, it may be equally beneficial to have an elongate receiver as an elongate transmitter. Both have the property of providing an average shorter path TOF from transmitter via finger to receiver than for point-based transducers, which is advantageous for avoiding hand-to-finger interference.

To successfully track a finger above a surface with a system having at least one elongate transmitter or receiver, it is beneficial to provide means for enabling distance along a depth axis to be calculated; this could be used to detect if the finger moves away from a tracking surface. Hence, the use of at least one elongate transducer forms a preferred feature of all of the earlier aspects of the present invention aimed at obtaining separation between a target hand part and other objects. Preferably a sufficient number of transducers is provided to enable three-dimensional positioning; in this way apparatus according to the invention may preferably provide a “touch-screen” mode and also a “three-dimensional” finger positioning mode and may advantageously be able to switch smoothly between these two modes.

In preferred arrangements at least three receivers are provided, arranged to allow the position of the object to be determined in three dimensions. This is particularly beneficial as it allows, for example, movement of a finger to be tracked without constraining the finger to movement within a specific plane—i.e. effectively allowing a ‘touchless’ system rather than just a ‘touch’ system, but at the same time using an elongate transducer enables ensuring that the finger's echo or reflection can be distinguished from that of the hand. In fact such an arrangement can allow a seamless transition from a touch-based system to a touchless system tracking the finger using the same transducers.

This is novel and inventive in its own right and thus when viewed from a further aspect the invention provides apparatus for tracking movement of an object, the apparatus comprising: at least four transducers for transmitting or receiving locating signals, wherein at least one of said transducers is elongate, the transducers being arranged to define a tracking space in which the position of said object can be determined in three dimensions; and means for processing the signals received by at least three transmitter-receiver pairs of said transducers to determine the location of said object in said tracking space.

The tracking space could be completely open, i.e. free space, or in some embodiments at least three of the transducers (typically including the elongate one) could be located so as to be coplanar with a physical surface defining a touch-pad (either passive or in the form of a display). This would allow a seamless transition between interacting with the touchpad conventionally and doing so touchlessly—i.e. separated from the surface.

Of course the numbers of transducers are minima: more than four transducers could be used and/or more than one elongate one. In some embodiments the elongate transducer is a transmitter but it could be a receiver.

A particularly useful design for enabling touch-screen or near-screen control for a display screen by determining the position of a finger relative to the screen such that it can be tracked, following the principles for successful hand-finger separation may be provided by arranging transmitter and receiver pairs in largely across-screen fashion; i.e. the transmitter of each pair lying across the screen from the receiver of the pair with an imaginary line between the two dividing the screen into two portions; e.g. substantially equal portions, or with the smaller portion being at least 10% or 25% or 40% of the screen area. Important advantages can thereby be obtained over more general sensor configurations. The points above apply equally to any other control surface, not necessarily a screen.

First, the path TOF from transmitter to finger to receiver is short even when the finger is close to the surface, at least for the transmitter-receiver pairs for which the path TOF is the shortest. This is true both for transducer pairs arranged to become largely ‘horizontal channels’ or ‘vertical channels’ or ‘diagonal channels’ or channels having any in-between orientation. This short ‘average TOFs’ also ensures good separation in TOF between finger and hand, for most relevant orientations of the hand.

Secondly, the short average TOF means that only a few impulse response taps need to be estimated and/or used.

Finally, by inspecting these short segments of impulse responses per channel, i.e. per transmitter-receiver-pair, the approximate position of the finger can be obtained even without accurate xyz-tracking. Instead, it can be accomplished by simply sensing the presence of an object within a few taps of the impulse response of the channel, by using i.e. a thresholding technique or edge detection technique. This can be done while removing the contribution of the direct path signal from transmitter to receiver by means of subtraction or adaptive filtering. The presence detector could work either by detecting more energy in a specific part of the impulse response, or by detecting “shadowing” of the receiver by the finger, in the case where the finger is straight in between the transmitter and receiver, or using combinations of the two.

All the above advantages are consequences of the careful transducer configurations employed to separate the position of the finger from that of the hand. This latter across-screen design is particularly useful for providing a low-cost alternative to conventional touch-screen technologies, appropriate for many electronic devices such as LCD photo-frames, GPS systems, televisions or radios.

The inventor has realised that an alternative approach to reducing the possibility of signal path confusion when determining the location of an object using time-of-flight methods is rather than using separate discrete transducers or elongate transducers, to employ a two dimensional transducer arranged to receive over all or substantially all of its surface which constitutes a tracking zone (in two dimensions) or one face of a tracking zone (in three dimensions).

Accordingly, from a further aspect, the invention provides a method of determining the location of an object comprising:
transmitting a signal into a tracking zone;
receiving a reflection of said signal from said object at a receiving surface defining a tracking zone or face of a tracking zone; and
determining the location of the object from the time of flight of the signal.

The invention extends to apparatus for determining the location of an object comprising:
a transmitter for transmitting a signal into a tracking zone;
a receiver having a receiving surface defining a tracking zone or face of a tracking zone for receiving a reflection of said signal from said object; and
means for determining the location of the object from the time of flight of the signal.

The receiving surface could be of any type—e.g. a dedicated panel or another surface. Preferably however the receiving surface comprises a display panel—e.g. a display screen. This allows for convenient and discreet integration of the tracking apparatus with a display. The receiving surface could have an integral sensitivity to the signals—i.e. such that the surface is used as a sensor itself, or it could be comprise a plurality of discrete sensors coupled to it, so that the signals received at the surface could be used to detect where on the surface the signal and any secondary echoes first hit the surface.

Preferably the object is a human digit.

Technology for causing a panel to receive sound is well known; for example by a panel of glass or plexiglass with the proper characteristics would be moved when struck by an ultrasonic signal. This approach stands in contrast to the approach of using acoustic surface waves or bending waves in touch screens displays not least because the waves are generated by and are emitted from the surface itself.

Preferably the panel is flat. The importance of this to realising modern product design needs was explained earlier. When this is the case, it will be appreciated that, in contrast to the situation for peripherally-mounted receivers, an acoustic signal received by the panel itself will necessarily have a shorter TOF between the transmitter, a user's fingertip and the flat panel the receiver than any other part of the user's hand, wherever the fingertip may be, so long as it is the closest part of the hand to the panel. Therefore, with suitably placed receivers, it is possible to mitigate the problem of a part of the user's hand other than the intended fingertip being incorrectly determined as being the closest object to the screen.

A further advantage of some embodiments of this aspect of the invention may be found in a simplification of the calculations necessary to determine the location of the object. In particular, rather than an intersection-of-ellipses calculation being required, a trilateration approach may be used, based on the time of arrival of the echoes at each of a plurality of receivers.

For all the above aspects, the preferred features of any one aspect may, wherever appropriate, equally be applied to any of the other aspects.

As used herein the term ‘transducer’ is a generic term for a transmitter or a receiver, or indeed for a component capable of performing both functions.

Certain preferred embodiments of the invention will now be described, by way of example only, with reference to the accompanying drawings, in which:

FIG. 1 is a front projection of an input tracking system shown for reference purposes only;

FIG. 2 is a top projection of the system of FIG. 1 showing a user interacting with the system;

FIG. 3 is another top projection of the system of FIG. 2 illustrating a shortcoming of the system;

FIG. 4 is a front projection of a multiple-transducer input tracking system in accordance with an embodiment of the invention;

FIG. 5 is a top projection of the embodiment of FIG. 4 showing a user interacting with the system;

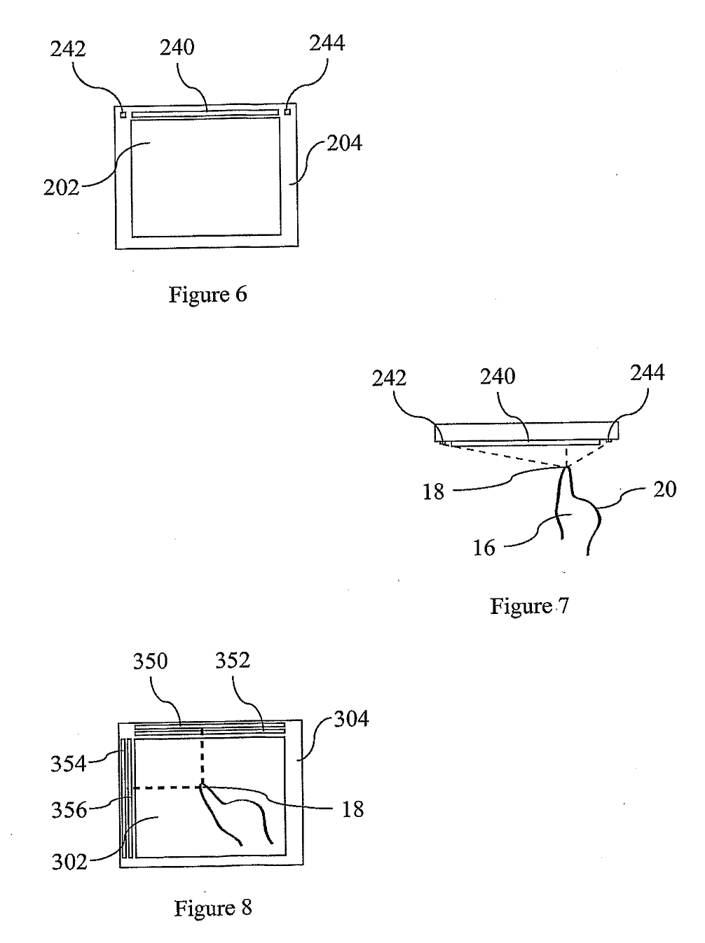

FIG. 6 is a front projection of an input tracking system with elongate transducer in accordance with another embodiment of the invention;

FIG. 7 is a top projection of the embodiment of FIG. 6 showing a user interacting with the system;

FIG. 8 is a front projection of an input tracking system with multiple elongate transducers in accordance with a third embodiment of the invention showing a user interacting with the system;

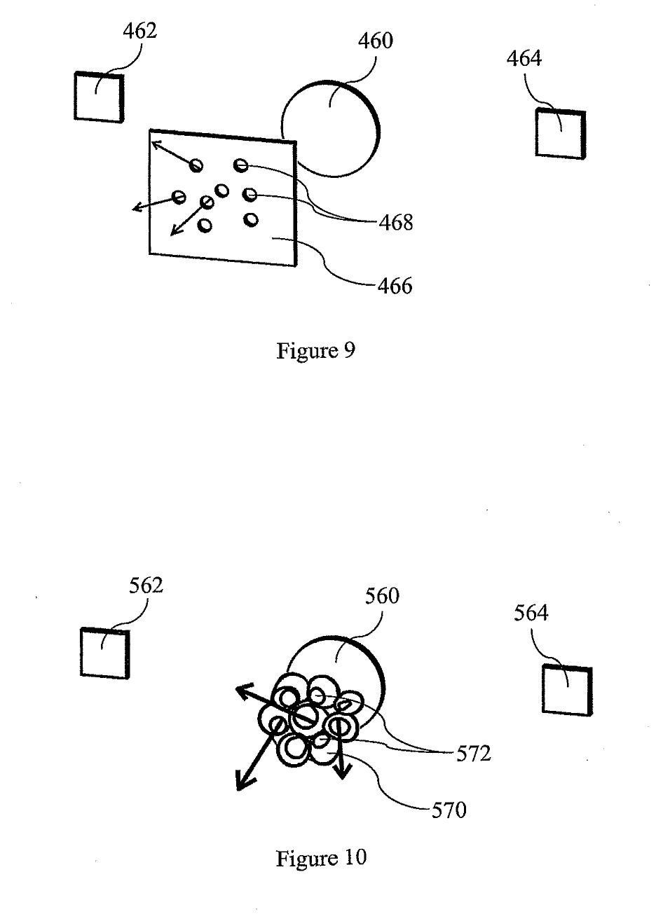

FIG. 9 is a perspective drawing of part of an object location system having a scattering structure in accordance with a fourth embodiment of the invention;

FIG. 10 is a perspective drawing of part of another object location system having a scattering structure in accordance with a fifth embodiment of the invention;

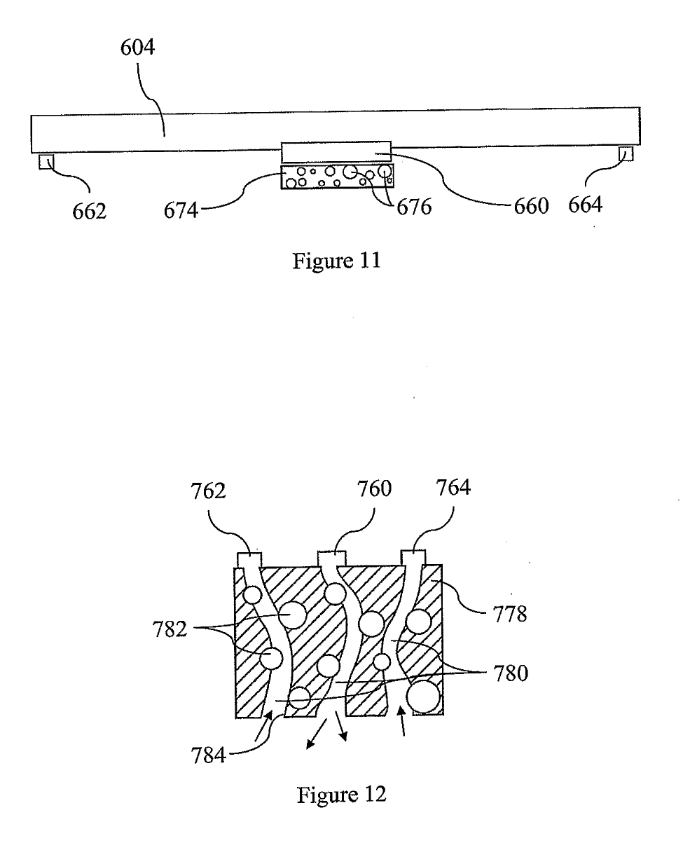

FIG. 11 is a top projection of an object location system having a scattering structure in accordance with a sixth embodiment of the invention;

FIG. 12 is a horizontal cross-section through a table-top tracking system in accordance with a seventh embodiment of the invention;

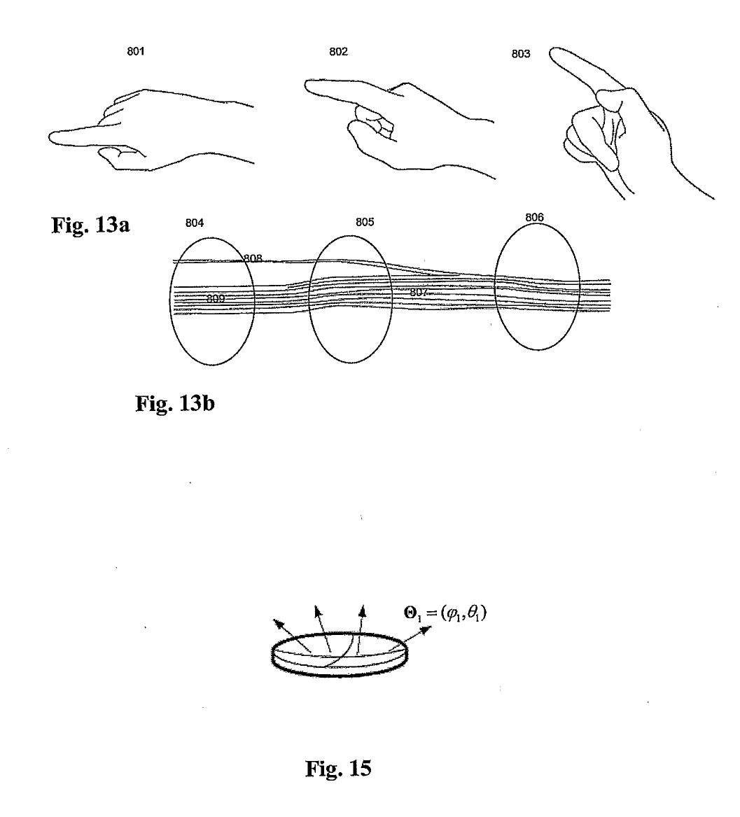

FIG. 13a is a series of diagrams showing movement of a hand to illustrate operation of an embodiment of the invention in more detail;

FIG. 13b is a corresponding series of impulse responses;

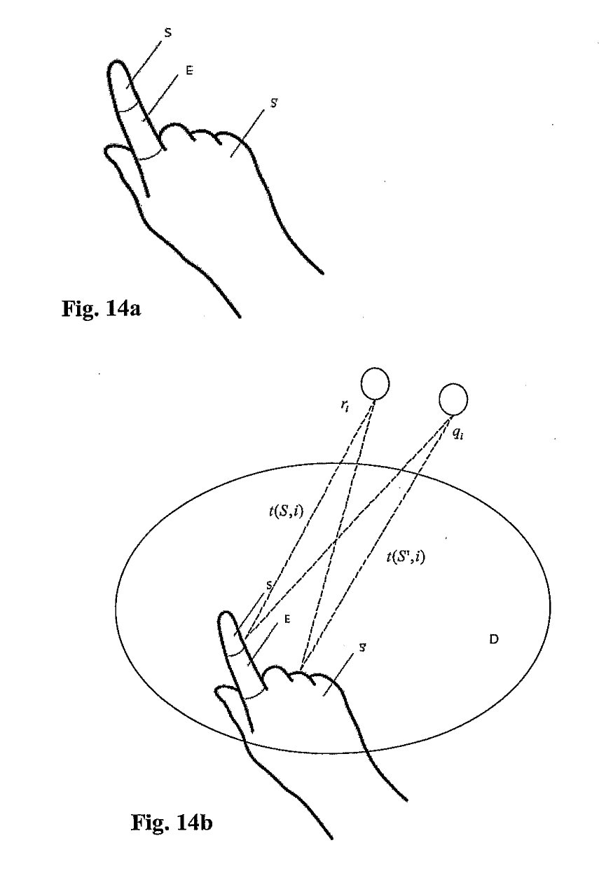

FIG. 14a is a diagram showing different parts of a hand;

FIG. 14b is a diagram showing signal paths reflected from parts of the hand;

FIG. 15 is a schematic diagram showing the directional pattern of a transducer;

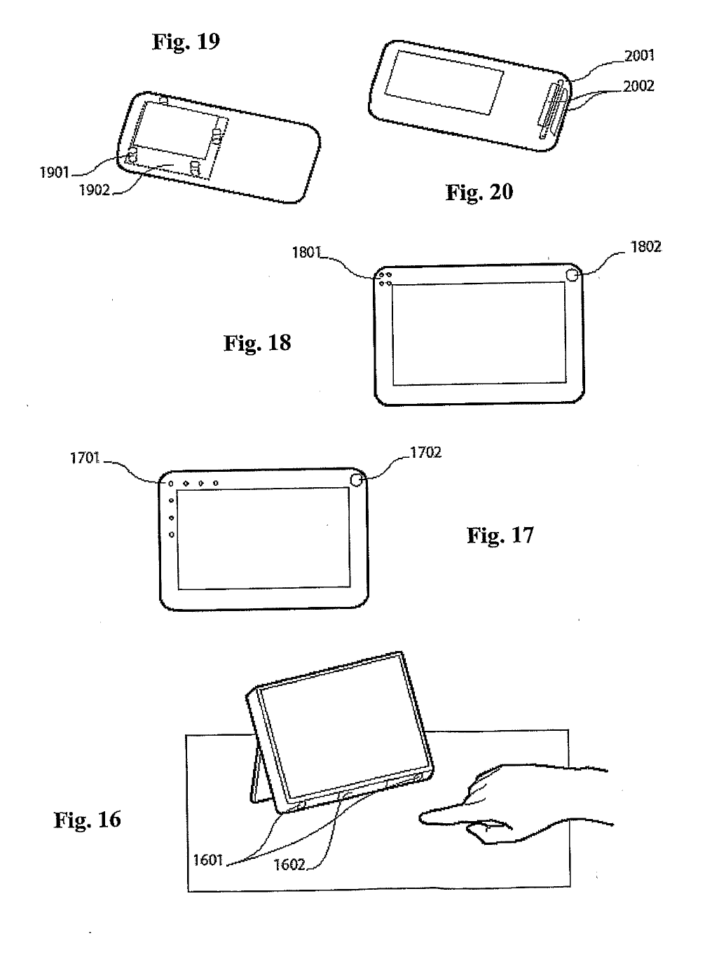

FIG. 16 is a schematic drawing of a device in accordance with another embodiment of the invention;

FIG. 17 is a schematic drawing of a device in accordance with a further embodiment of the invention; and

FIGS. 19 and 20 are schematic drawings of a mobile phone embodying the invention.

As explained hereinabove, FIGS. 1 to 3 show how the layout of transducers can give rise to problems with correctly identifying the part of a user's hand closest to a transducer array which can cause problems in trying to track movement of the user's fingertip. These problems can also be understood by considering the impulse response images as will be explained below with reference to FIGS. 13a, 13b and 14.

Turning to FIG. 13a, there is shown a hand 801 pointing towards the screen which is located to the left of the Figures. Across the series of three diagrams the finger begins to turn upwards 802 before finally pointing upwards 803. The effect of this movement on the echo-location results can be seen by studying the curves 807 in FIG. 13b. Theses curve represent the ‘impulse response image’ of a recording of the scene where the finger moves as indicated in steps 801-803.

An impulse response image is a sampling of the impulse response of the system taken over time. The ‘impulse response’ is defined as the response of the system when an impulse is driven into it. In this case, the impulse response is the recorded effect of an impulse signal being transmitted from the transmitter, reflecting off the finger and the rest of the hand, and then being received by the receiver. The impulse response can also be computed by other means, such as by cross-correlation or inversion techniques if signals other than Dirac pulses are driven through the system.

Let h(t,s) denote the impulse response at delay s sampled around time t. Typically, t will be sampled at intervals of, say 120 Hz, and the number of taps recorded will be between 100 to 200. The impulse response image can then precisely be defined as:

$$H = \{ {h}_{ij} \} , {h}_{ij} = h ( {t}_{i} , {s}_{j} ) , \{ \begin{matrix}i ∈ [ {i}_{0} , {i}_{1} ] , j ∈ [ {j}_{0} , {j}_{1} ] , \\ {t}_{i} = {t}_{0} + Δ t \cdot i \\ {s}_{j} = {s}_{0} + \frac{j}{f}\end{matrix}$$

Where [i₀,i₁] denotes the interval of time snapshots for which the image is generated, Δt denotes the spacing in time between successive recordings of the impulse response, [j₀,j₁] denotes the interval of filter tap indices in the impulse responses investigated, and ƒ denotes the sampling rate of the system. t₀ and s₀ denote the start of the sampling in time and in filter tap index respectively. The contours of this matrix are shown in FIG. 13b as a continuum of curves 807. In this image, the echoes stemming from a reflecting object at a given distance can be seen as a line. If the object is static, the line will be straight; if it is moving, the motion of the curve will correspond with the distance change of the reflective object relative to the transmitter/receiver pair. When mapping this over to the motion of the fingers for touchless applications, it can be seen that the hand position 801 yields a corresponding impulse response 804 where the echo of the finger 808 is well separated from the echo of the hand 809. As the finger starts tilting 802 the echoes of the finger and the hand start getting closer to one another 805. Finally, when the finger is pointing upwards 803, the echoes of the finger and the hand respectively are overlapping and cannot be straightforwardly resolved 806.

A similar effect occurs when the finger moves away from the centre of the screen towards one side. In this case some transmitter and receiver pairs will see the finger as if it were in the ‘upwards’ orientation 803 shown in FIG. 13a.

The curve seen in 807 could also represent the action of a finger straightened out from the hand and subsequently being folded to become part of the fist. Detection of such an action from the impulse response image could be used to detect a ‘click’ gesture.

The impulse response images each correspond to a particular channel—i.e. transmitter and receiver pair. As an initial step the impulse responses from each channel are compared so that the ‘best’ one or more are chosen, based on which display the best separation between the fingertip and the rest of the hand.

Not all screens or surfaces are in need of sensor placement or selection to avoid hand finger confusion. For a relatively small screen or surface such as a mobile telephone, various, straightforward and/or symmetric placements of sensors, such as, say, three transducers operable interchangeably as transmitter and receiver, one placed on top and one in each of the lower corners, will suffice to avoid this confusion. With the size of the screen being small in comparison with the hand, finger/hand confusion will only arise when the finger starts pointing outside of the screen.

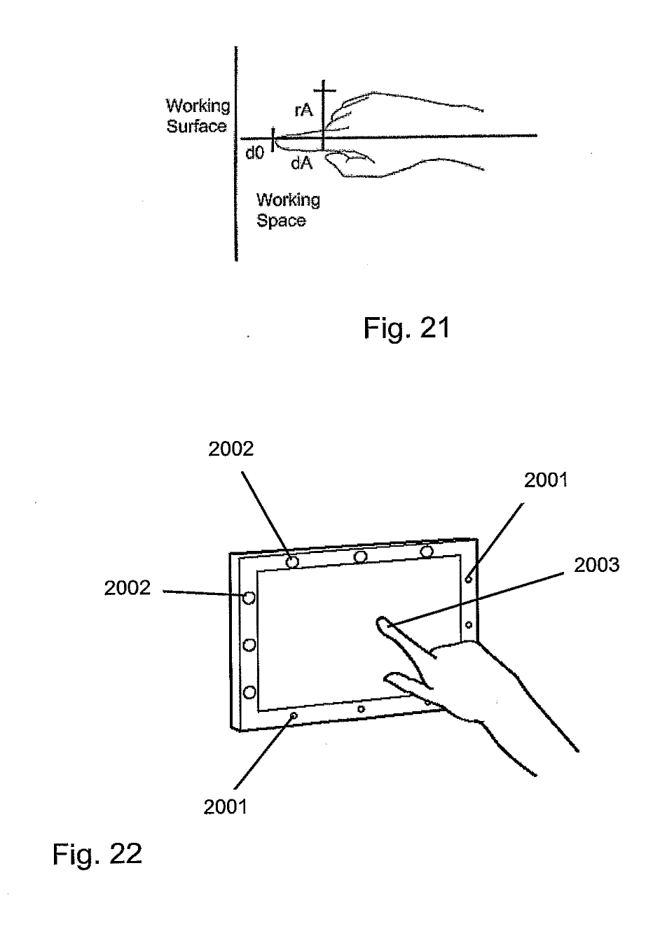

Whether, in a given situation, there is an actual need to take steps towards resolving hand/finger confusion in accordance with the invention is readily testable. A suitable test is dependent on the working surface, the area wherein the sensors can be located (such as e.g. the frame of a screen), and the design specification: that is, what kind of operation is admissible for the system to be functional? The latter is usually a decision made by an interaction designer, and can amount to statements such as “the user must be able to choose to use either the left or the right hand” (which is reasonable), or “the system must work whether the palm of the rest of the hand, i.e. not the finger pointing towards the screen is facing upwards, downward or sideways” (which is a stricter requirement) or “the system must work also when the finger is pointing sideways into the screen” (which is an even stricter requirement), or “the system must work even when a baby is using it” (which is very strict). To decide whether hand/finger confusion issues arise, the following test can be carried out: For a given working surface, and for a given configuration of sensors, let a (preferably large) number of users point towards the screen, all over the screen, in a manner they find natural. Meanwhile, the interaction designer observes, and marks off the set of positions which she feels the system shouldn't be required to handle. This leaves a set of pointing positions and hand poises which the system should be able to handle. If, for one or more of these poises, the system channels are inspected, and an overlap in the TOF is observed for the finger and for another potentially interfering reflector such as another finger, a knuckle, or some other part of a hand, then steps need to be taken towards resolving the hand/finger confusion. To give a specific example, a designer can decide a specification by giving values to the following parameters illustrated in FIG. 21:
The minimum distance d0 that the front pointing finger may have to the working surface
The minimum distance dA that the other, possibly interfering fingers or hand parts can have to the working surface while the front pointing finger is being tracked
The maximum radius rA that the other fingers may have from the axis going through the front pointing finger while the system is tracking the front pointing finger.
An interval I of possible angles wherein the potentially interfering object may lay [not drawn], along the radius rA.

The specification chosen by the designer will determine the extent to which hand/finger confusion would arise were principles in accordance with the invention not to be applied. For example simulations have shown that for a 5×5 cm screen, with a minimum distance d0=0, dA=4 cm and rA=5 cm and an interval I or any possible angle the transducers can be placed to give even just three channels to avoid hand/finger confusion issues without necessarily employing principles in accordance with the invention. On the other hand, simulations have shown that for a 10×10 cm screen with the same specifications for d0, dA rA and I, the principles in accordance with the invention are needed to avoid hand/finger confusion issues that would otherwise are resolved. Hence, for this specification, the invention does apply. Moreover simulations also show that even for a 5×5 cm screen, with distances d0=0, rA=5 cm, and I=any angle as before, but with dA=2 cm i.e. allowing the other fingers to be closer to the screen, which is convenient for a mobile application which is less selective with respect to the positions of the other fingers in use, the confusion problems do arise, and hence the principles according to the invention must be employed to resolve these.

FIG. 4 shows a front projection of an finger-input tracking system embodying the invention which does not suffer from the problems referred to above. A rectangular flat-panel display screen 102 is surrounded by a frame 104, along the top edge of which is mounted a row of alternating ultrasound transmitters and receivers. From left to right this row comprises: a far-left receiver 134, a left transmitter 130, a central receiver 136, a right transmitter 132 and a far-right receiver 138.

FIG. 5 shows the system of FIG. 4 from a top projection with a user interacting with the system. When the user's hand 16 is towards the left side of the screen 102, the left transmitter 130 can be emit an impulse to be detected by nearby receivers; i.e. the far-left receiver 134, the central receiver 136 and any other receivers mounted towards the left side of the display (not shown) such as along the left or bottom edges of the frame 104. When the user's hand 16 is towards the right side of the screen (as indicated by the dashed outline) the right transmitter 132 can be used in conjunction with the central receiver 136, the far-right receiver 138 and any other receivers towards the right side of the display. In this way it is ensured that parts of the user's hand 16 other than the tip of the index finger, such as the knuckle 20 of the little finger, are never the closest point to any of the active transmitter-receiver pairs. The system therefore avoids the problem exemplified by the arrangement of FIG. 1 in which an undesired impulse response from a part of the hand other than the fingertip can prevent the system from being able to locate the fingertip. The determination to switch from using the left transmitter 130 for position determination to using the right transmitter 132 may be based on any suitable means such as using assumptions of continuity of movement of the fingertip to track and predict its location, from the absolute time taken for one or more of the receivers to receive an echo, or by some entirely separate system such as an arrangement of infrared beams.

The arrangement of FIGS. 4 and 5 avoids the problematic situation which can arise in the situation described with reference to FIGS. 1 to 3 and 13a, 13b by placing the transmitters and receivers according to a principle where the above confusion does not arise by accident.

FIGS. 17 and 18 show further examples of inventions which do not suffer from problems referenced above. In FIG. 17, the receivers 1701 are typically so far to the left and up that situations where the finger is confused with the hand whenever the finger is located approximately in front of the screen as sound travels from the transmitter 1702 to the finger (not shown) to the receivers 1701 do not arise. In FIG. 18, there are multiple receivers allowing directional information to be gathered as will be explained later below. In both FIGS. 18 and 17, the transmitters could be replaced by receivers and vice versa. It will be noted that in these Figures, the transmitter 1702; 1802 is separated from each of the receivers 1701; 1801 by more than a quarter of the length of the shortest side of the screen. In the case of FIG. 17, the receivers 1701 are not all on the same side of the screen as the transmitter 1702. The receivers are separated from one another by a distance of more than half the maximum wavelength of the ultrasonic signals employed.

Turning to FIGS. 14a and 14b, S denotes the area of the finger which is sought to be tracked, E denotes an area which is not of interest, or which does not reflect enough energy to confuse the tracker, and S′ denotes the area of the hand which may confuse the tracker, and whose impact on the echoes is to be avoided. The transducers are placed so that within a predetermined zone of operation, there always exists at least one pair of transducers for which the travel time of the echoes from any point in S is less than the travel time for the echoes for any point located within S′. Reformulated, it can be stated that the times-of-flight (TOFs) between transmitter, object and receiver, is such that for at least one pair of transmitters and receivers, the point having the longest TOF within S has a TOF which is shorter than the shortest TOF for any point within S′.

Analysing this in an ultrasonic system, let t(S,i) denote the travel time of a signal transmitted and received over the i'th channel being reflected by that point in S giving the longest travel time, i.e.

$$t ( S , i ) = {max}_{p ε S} \frac{1}{c} ( ‖ p - {r}_{i} ‖ + ‖ p - {q}_{i} ‖ )$$

Where c is the speed of sound, and (rᵢ,qᵢ) denotes the locations of the receiver and the transmitter in the i'th transmit/receive pair respectively. The value is maximized over all points p lying within the tracking finger zone S. Furthermore, let t(S′,i) denote the travel time of a signal transmitted and received over the i'th channel being reflected by that point in S′ giving the shortest travel time, i.e.

$$t ( {S}^{′} , i ) = {min}_{p ε {S}^{′}} \frac{c}{f} ( ‖ p - {r}_{i} ‖ + ‖ p - {q}_{i} ‖ )$$

The requirement is that the locations of the transmitters and the receivers satisfy

$$[ {\sum }_{i = 1}^{N} I ( t ( S , i ) > t ( {S}^{′} , i ) ] \geq 2 \qquad (* )$$

Where N is the number of channels, i.e. transmitter/receiver pairs, I is the indicator function for a statement being true (i.e. I(2>1)=1, whereas I(1>2)=0). The relation (*) must hold for every S⊂D , where D is the zone of operation in space. For tracking in three dimensions the number on the right hand side of the equation must be 3. The situation can be better appreciated by studying FIG. 14b, showing a transmitter and a receiver pair, (rᵢ, qᵢ), the operating zone D, the finger zone to be tracked S, the zone of the interfering hand S′, and the zone which is not of interest or which is not reflecting strong energy E. The reason that E may not reflect strong energy may be due to continuous point smearing effects combined with the intrinsic high-pass filtering resulting from ultrasonic transmission and reception.

The above equation (*) is true for the ideal case of infinite bandwidth. For band-limited systems, the requirement is that the distances t(S,i) and t(S′,i) must be sufficiently far apart for the system's bandwidth to separate them. This means that that at least a pair of channels (for two-dimensional tracking) or three channels (for three-dimensional tracking) should satisfy

$$\vert t ( S , i ) - t ( {S}^{′} , i ) \vert > \frac{1}{Bf}$$

Where B is the system's bandwidth, and ƒ is the sampling frequency of the system. If the system has full bandwidth relative to the sampling frequency (i.e. B=1), then at least one sampling periods are needed between the echoes to separate them Hence, we propose to place the sensors (rᵢ,qᵢ), such that

$$[ {\sum }_{i = 1}^{N} I ( \vert t ( S , i ) - t ( {S}^{′} , i ) \vert > \frac{1}{Bf} ) ] \geq 2$$

For two-dimensional tracking, and larger or equal to three for three-dimensional tracking.

Thus, in the preferred mode of the invention, there exists a particular relationship between time-of-flight distances between pairs of transducers, points within a ‘tracking object zone’, such as a finger, and points within an ‘interfering object zone’, such as a hand. In particular, in the preferred embodiments of the invention, the sensors are placed such that in order to track an object located within a predetermined zone, the longest TOF over all points within the tracking object zone is separated from the shortest TOF for over all points in the interfering object zone by at least a distance which is equal to one divided by the product of the bandwidth and the sampling frequency of the system. This has been found to enable separation of a fingertip from the rest of the hand from a single impulse response. If multiple consecutive impulse responses are used, it may be possible to achieve an acceptable result (i.e. enable separation of the motion of the finger from the motion of the hand) by having an even smaller gap between the respective TOFs.

In addition to or as an alternative to careful placement of the transducers, the problem of hand/finger confusion can be improved by increasing the number of channels beyond the minimum requirement (two or three), and at a later stage selecting which one to use for the final positioning of the fingertip. There are many ways of selecting which of the channels are to be used. One way is to inspect the channels' impulse responses for potential overlaps or non-overlaps. Another is to have several tracking positions candidates, each relating to different combinations of channels, and only at a later stage in the algorithm deciding which channel sets were appropriate based on measures such as curve continuity or predictability. Again, some channels could be used purely or partly for “presence location”, and thereby the system can know with which channels to use and which ones not to use.

FIG. 6 show a front view of a finger input system embodying the invention having a rectangular flat-panel display 202 surrounded by a frame 204 on which is mounted a left receiver 242 in the top-left corner, a right receiver 244 in the top-right corner, and an elongate transmitter 240 along the top of the display area 202 and exactly spanning the width of the display area. The elongate transmitter 240 comprises a long, narrow, thin film mounted on piezo electric drivers which are operable to cause the elongate transmitter to emit ultrasonic impulses substantially instantaneously from along its entire length. In order to obtain more precise position information, such as the distance of the finger perpendicularly away from the plane of the display 202, additional transducers (either elongate or conventional) may be mounted around the frame.

FIG. 7 shows a top projection of the embodiment of FIG. 6. A user's hand 16 is shown interacting with the system. Wherever the user's index fingertip 18 is located within the confines of the frame 204, the shortest line from it to the elongate transmitter 240 will necessarily be perpendicular to the elongate transmitter. Because of this, it is less likely that another part of the user's hand 16, such as the knuckle of the little finger 20 will prevent the obtaining of an accurate position determination than would be the case for the arrangement of FIG. 1.

FIG. 8 shows a front view of a finger input system embodying the invention having a rectangular display 302 surrounded by a frame 304 along the top of which are mounted an elongate transmitter 350 and an elongate receiver 352, both lying parallel to the top edge of the display 302, the elongate transmitter 350 lying a little further from the display 302 than the elongate receiver 352 does. Similarly, a further elongate transmitter 356 and an elongate receiver 354 are mounted in the left edge of the frame 304, lying parallel to the left edge of the display. Each elongate transducer spans the full length of the display edge adjacent it. Dashed lines indicate the travel of two ultrasonic impulses outwards and their reflections backwards along the shortest time-of-flight path via a user's index fingertip 18 for each elongate transmitter and its adjacent elongate receiver.

Since, wherever the user's fingertip 18 is situated on the surface of the display 302, and is pointing in a direction is substantially perpendicular to the display, the two shortest return impulse paths will necessarily be perpendicular to the respective elongate transmitters and their adjacent receivers, x- and y-coordinates can be obtained directly from time-of-flight measurements for the two paths respective, needing only scaling by a constant factor; no calculation regarding the intersection of ellipses is required, thereby significantly reducing the computational complexity of processing the signals to determine the location of the fingertip 18. This embodiment gives accurate position determinations for a fingertip 18 lying in the plane of the display 302, i.e. touching. This is an important advantage over an optical system which could have ‘dead angles’ close to the screen. On the other hand however, acceptable accuracy can still be achieved when the fingertip 18 is close to, but not touching, the display surface. This flexibility to be operable whether the finger is touching or not is another significant advantage. In order to eliminate cursor movements from objects, including the fingertip, when they are not touching or nearly touching the display surface, a separate mechanism for detecting proximity to the display surface may be employed, such as a capacitive detection system (which would have the advantage that it could be integrated as part of the screen) or an infrared sheet of light. The cursor might then only be allowed to move when this mechanism is triggered. Alternatively or additionally further transducers may be located on the frame 304.

FIG. 9 shows part of an object location system embodying the invention and suitable for mounting a frame surrounding a flat-panel display such as has been represented in earlier Figures. It shows a left receiver 462 and a right receiver 464 situated on either side of a central transmitter 460. Directly in front of the transmitter is a scattering structure 466 comprising a substantially flat board with a plurality of irregularly-spaced holes 468 drilled through it. When an acoustic impulse is emitted by the central transmitter 460, it passes through the holes 468, each of which acts substantially as a point emitter, radiating hemispherically. The acoustic waves passing through the holes 468 will interfere with each other constructively and destructively to produce regions of relatively high intensity sound and regions of relatively low intensity sound.

The combined effect of these is to produce an output signal from the transmitter which has a complicated pattern of variation with direction. By applying a suitable inverse function, the corresponding receiver can determine or estimate the direction from which a particular signal was incident on the object before it was reflected. This is valuable information for assisting in locating and tracking the movement of an object and can allow for example a reduction in the number of transmitter-receiver pairs required for accurate location.

A more detailed description will now be given of how the inverse directional function is applied. FIG. 15 represents the system schematically as a transmitter from which sound will propagate in various directions, but with effectively different filters applied to each direction. For instance, in the direction indicated by the vector Θ₁=(φ₁,θ₁), the signal received by a receiver along this direction of propagation can be represented as

y(t)=b(Θ₁,t)*x(t−τ)

Where ‘*’ denotes the linear convolution operator, and r is a delay parameter which depends on the distance between the transmitter and the receiver. b(Θ₁,t) is the filter representing the convolution of the signal in the propagating direction. If the sound bounces off a first scattering object, and is subsequently received by a receiver, then the received signal will further be modified to become

y(t)=b(Θ₁,t)*s₁(t)*x(t)

Where s₁(t) defines the echoic impulse response or ‘filtering effect’ of the scattering object when traveling from one transducer, bouncing off the object and being received by the other. In this equation, the term −τ has been removed, since it can conveniently be modelled into s₁(t). Now, for every transducer pair, there will be a number of scatterers which are ‘seen’, hence:

$$y ( t ) = {\sum }_{i = 1}^{N} b ( {Θ}_{i} , t ) * {s}_{i} ( t ) * x ( t )$$

The term y(t) now denotes the sum of the echoic effects of transmitting x(t) which bounces off a number of scattering objects, each with their own impulse response. As an approximation of the continuous case the set of all possible angles is subdivided into a discrete set of N different angles representing this continuum. However, in many directions there will be no echo, hence the expression can be simplified further. Let S denote the set of directions for which there is an echo. These can conveniently be found approximately by an initial scan over the entire set of directions, or by using prior knowledge about the objects' locations. Now:

$$y ( t ) = {\sum }_{i ε S}^{ } b ( {Θ}_{i} , t ) * {s}_{i} ( t ) * x ( t )$$

What is wanted is to create filters that can separate some directions from others. A filter ƒₖ(t) is required such that:

ƒₖ(t)*y(t)=sₖ(t)*x(t)

In other words, the filter retrieves the impulse response of the scatterer lying along the k'th direction, convolved by the output signal x(t). Ideally, this filter should be applicable no matter what the signal x(t) is. Naturally if x(t) is known this could be used to design a better filter, but for now the case considered is that the time series x(t) can take on any set of values. Since it is the impulse response sₖ(t) which is of interest, it can conveniently be assumed that x(t) is a Dirac delta signal, or a sinc function, i.e. a band-limited Dirac delta in the practical situation where x(t) is band-limited. Even if x(t) is not a Dirac signal, the effect of x(t) in the equations can be removed either by cross-correlating by x(−t) (if x(t) is white), or by signal inversion or by matrix inversion principles. Informally speaking, this would have the effect of ‘dividing out’ x(t) on both sides of the equation. There is now:

$${y}^{′} ( t ) = {\sum }_{i ε S}^{ } b ( {Θ}_{i} , t ) * {s}_{i} ( t )$$

As a simple example, assume that there are only three directions from which there are significant reflections. For notational convenience, set b(Θᵢ,t)=bᵢ(t) and so:

y′(t)=b₁(t)*s₁(t)+b₂(t)*s₂(t)+b₃(t)*s₃(t)

What is wanted is to find a filter ƒₖ, that when convolved by the k'th filter bₖ(t), yields a Dirac delta filter ∂(t), and when convolved by another filter, gives a signal which is close to zero in all its relevant parts. For instance, ƒ₁ should ideally be designed such that

$$\begin{matrix}{f}_{1} ( t ) * {y}^{′} ( t ) = {f}_{1} ( t ) * [ {b}_{1} ( t ) * {s}_{1} ( t ) + {b}_{2} ( t ) * {s}_{2} ( t ) + {b}_{3} ( t ) * {s}_{3} ( t ) ] \\ = {\underbrace{{f}_{1} ( t ) * {b}_{1} ( t )}}_{\partial ( t )} * {s}_{1} ( t ) + {\underbrace{{f}_{1} ( t ) * {b}_{2} ( t )}}_{0} * {s}_{2} ( t ) + {\underbrace{{f}_{1} ( t ) * {b}_{3} ( t )}}_{0} * {s}_{3} ( t ) \\ = {s}_{1} ( t )\end{matrix}$$

i.e. the impulse response from the object lying in the ‘first’ direction. Essentially, what is wanted is:

ƒ₁(t)*b₁(t)=∂(t)

ƒ₁(t)*b₂(t)=0

ƒ₁(t)*b₂(t)=0

Where 0 here denotes a time-series of zero elements. In practice this might not be attainable, but an approximation can be achieved as follows. As is well known in the art, a convolution can be written in matrix form. For instance, the convolution ƒ(t)*b(t)=b(t)*ƒ(t) can be written as the matrix/vector product Bƒ, where B is a N by K Toeplitz vector representing the convolution function B, and ƒ a length K vector containing the K filter taps of the signal ƒ(t). N is equal to the K plus the length of the filter b(t) minus one. The set of matrix equations obtained using this principle are

B₁ƒ₁=d

B₂ƒ₁=0

B₃ƒ₁=0

Where d is a N-vector with zeros everywhere but in its centre element, thus being a vector representing the dirac delta function, and 0 is a N-vector with only zero elements. In block matrix form, the equation system becomes

$$[ \begin{matrix}{B}_{1} \\ {B}_{2} \\ {B}_{3}\end{matrix} ] {f}_{1} = [ \begin{matrix}d \\ 0 \\ 0\end{matrix} ]$$

The filter ƒ₁ can then be computed by multiplying the left hand block matrix pseudo-inverse, or a regularized inverse, by the right hand vector. Clearly, it will not always be ideal to construct d such that it is a Dirac function. In the practical case, the channel will be band-limited, and it is better to choose d to fit a band-limited Dirac function, i.e. a cardinal sine or sinc function. In practice, there will also be a tradeoff between how well the filter ƒ₁ will suppress signal components from the filters b₂ and b₃, and how well it will fit to a Dirac delta or a sinc when matched with b₁. A number of tradeoff schemes could be envisioned here, such as modifications focusing only on suppressing the effects of b₂ and b₃ while sacrificing the shape of the Dirac delta or sinc-like function. Various other compromises could be struck, such as sacrificing suppression in some directions where it is known in advance that no scatterers exist, relative to others where important scatterers are known or assumed to be located. Sometimes, specifically-shaped signals which are not Dirac delta signals, will be the target of the inversion, such as a broader impulse response or an impulse response representative of a broad line, simplifying coarse resolution location, or an impulse response representing and edge could be used to simplify ‘leading edge detection’.

In the situation where there is only one scatterer in one direction, or in a plane of directions wherein the directional impulse response characteristics of the transducers are the same, the inverse filter procedure helps to ‘focus’ the signals received from that plane. In addition to this ‘directional filter inverse’ one can also apply a ‘mechanical filter inverse’ to compensate for reverberations due to mechanical or electric effects, which is different from compensating for the directional effects of the transducer.

Although the above method suggests a straightforward way of estimating the inversion filters, numerous modifications could be envisioned. For instance, the filters could further be improved based on knowledge of the output signal x(t). Prior knowledge of where scatterers are believed to be located could also be taken into account, by modifying x(t) to transmit signals with strong frequency components in the directions of propagation where scatterers are expected to be, or inversely, by emitting signals with no frequency components in directions where an ‘interfering’ scatter is expected to be. The filters can equally well be derived in the frequency domain, with various weighting of various frequencies, or they could be implemented in the time domain as matrix inverses of a general form, i.e. not necessarily Toeplitz matrices, serving the purpose of ‘unmapping’ the filtering of the echoes in the various direction. Filtering could also be carried out on the envelopes of the signals, or even on the envelopes of successive frequency bands. Particularly, if the objects have similar or equal reflective capacity in some frequency sub-bands, this could be used to increased the cross-range resolution of the system.

FIG. 10 shows part of an object location system embodying the invention and suitable for mounting a frame surrounding a flat-panel display such as has been represented in earlier Figures. It shows a left receiver 562 and a right receiver 564 situated on either side of a central transmitter 560. Directly in front of the transmitter is a scattering structure 566 comprising several roughly-spherical, hollow scattering components 570 packed closely together, each component having a rear opening (not shown) and a front opening 572 which is sufficiently large so as not to act as a simple point source for ultrasonic sound wave. The two openings allow sound to pass through the component. As an impulse from the central transmitter 560 passes through the scattering element, each scattering component 570 reinforces the sound in a particular direction, the net effect of which is that the sound emitted by the scattering element as a whole is of varying intensity and/or phase in different directions which is dependent on frequency—i.e. a ‘broadband signature’. Additionally, interference will occur between the waves emitted by each scattering component 570 adding further directional variation.

FIG. 11 shows the top of a finger input tracking system embodying the invention. It comprises a display screen frame 604 on the forward-facing top edge of which are mounted a central transmitter 660, a left receiver 662 and right receiver 664. The central transmitter 660 is substantially longer in a horizontal direction than it is deep and is relatively larger than either of the two receivers 662, 664. A scattering element 674 is located in front of the central transmitter 660. It comprises a substantially sound-porous medium in which are embedded irregularly-spaced reflective balls 676 made of a medium that substantially reflects sound. Both the transmitter and 660 and the scattering element 674 might alternatively be recessed into the frame 604, thereby retaining a flat front face to the frame 604.

In operation, sound from the central transmitter 660 bounces between the reflective balls 676 as it passes through the scattering element 660, thereby varying the path-length, and therefore phase, as well as the intensity depending on the direction in which the sound eventually leaves the front or side faces of the scattering element 674.

For each of the embodiments comprising a scattering element—i.e. those of FIGS. 9, 10 and 11—a scattering element could equally well be placed in front of one more of the receivers instead of or as well as the scattering element placed in front of the transmitter. The operation of each of these embodiments in determining the location of an object, such as a fingertip, is similar: an impulse is emitted from the transmitter and an echo from the object of interest is received at the receivers. In addition to conventional time-of-flight calculations for obtaining information relating to the location of the object, use is also made of the directional “colouring” of the impulse created by the scattering element. Beforehand, at least part of the directional effect of the scattering element is determined either by modelling or empirically; this determination is then inverted and applied to the received echo signals as described above. Especially when acoustic characteristics of the object, such as it reflectivity to sound, are already known, or are inferable from earlier impulse responses, it is possible to obtain additional information relating to the location of the object from the directionally-specific characteristics of the transmitted impulse. This can be used to filter out signals from unwanted directions. This could be both from sources outside the front of the screen, but also from e.g. other fingers or hand parts.

FIG. 12 shows a plan view of table-top tracking system embodying the invention. This embodiment does not comprise a display screen but is rather suited to tracking movements on or above a surface such as a table. It could, for example, be used to track finger movements similar to those made when using the touchpad of a laptop computer. The apparatus comprises a solid box 778 through which pass three non-cylindrical tubular voids 780. On the rear of the box are mounted an acoustic transmitter 760 and, on either side of the transmitter, two acoustic receivers 762, 764. The transmitter and receivers are each arranged to point forwards into respective ones of the three tubular voids 780. Also embedded within the volume of the box 778, and partially protruding into ones of the tubular voids 780, are several spherical reflectors 782. The tubular voids 780 have openings 784 on the front face of the box 778 so as to allow sound to enter and exit the voids.

In use, an acoustic signal is emitted from the central transmitter 760. This signal passes through the void 780 to the opening at the front of the box 778. Because the opening is not necessarily a point opening, the sound could be directionally focussed and, due to the non-cylindrical nature of the void, is of differing phase and intensity in different directions out from the front of the box 778. Furthermore, the spacing of the outlets and the subsequent summation of the outgoing wave will lead to directional effects even in situations where the holes themselves are cylindrical, due to the fact that there is not a single hole, but multiple holes, creating an overall ‘transducer’ which is not a point transducer and hence has directional characteristics. The spherical reflectors 782 further contribute to the directional nature of the sound and also prevent low-pass filtering effects arising from the otherwise smooth surfaces of the voids 780. Additionally, the use of multiple outlets allows for the use of one or more larger internal transducers, capable of delivering more total energy than a smaller transducer element, which would be more typical for a transducer located on the surface. When the distance from the transducer to the outlets is the same, this corresponds to using a ‘phase plug’, and in situations where they are not, a non-uniform wavefront is produced which will enhance the directional diversity of the transducer.

The voids 780 connected to the receivers 762, 764 have the same effect on sound entering the box 778—that this is indeed the case can be appreciated by noting the reciprocal nature of the wave equation (although noise characteristics may vary). In use therefore, directional “colouring” is applied to the sound both as it is emitted from the box 778 towards an object to be tracked, and as it is received back from the object. Knowledge of the effects of this directionality can be combined with information relating to time-of-flight to provide more accurate object location determinations than would be possible with just a conventional acoustic transmitter and pair of receivers.

Embodiments like that shown above could advantageously be incorporated in the housing of a device to allow it to be operated by a user. For instance, the transducers can be effectively embedded in the body of an electronic device with only one or a few small apertures being provided to allow access for signals. Taking one non-limiting example, consider the LCD photo display “S-frame DPF-V900” manufactured by Sony. To operate such a product touchlessly, it would previously have been necessary to mount a set of sensors around the screen, including a transmitter which would often be larger than the receivers thereby affecting the design. In accordance with the embodiments of the invention discussed here, however, the inlets and outlets for the transmitted energy could conveniently be placed underneath the frame. As the frame is slightly tilted when standing on a surface, there would still be enough room for the signals to come in and out of these holes, while for most users the modification would be practically invisible. The idea is illustrated in FIG. 16, (1601) showing the outlet for a transducer, or a transducer itself, (1602) showing, as a non-limiting example, the outlet for an elongate transducer, or alternatively, the transducer itself.

Another advantage of such arrangements the invention, is that they easily allow for multiple outlets and inlets of sound which can be used for tracking in different zones relative to a device using only a few transducers. For instance, a mobile device such as a cellular phone or PDA could have one or more transducers located at the inside of the cover, with multiple outlets and inlets. One set of outlets or inlets could be used for tracking in front of the mobile device, which is useful when holding it in ones hand while browsing. Another set of outlets and inlets to the same set of transducers could be located at the side or underneath the telephone to allow for tracking at sides of the mobile device when placed on a surface, such as a table. The concept is shown in FIG. 20, (2001) Showing the transducer inside the device, and (2002) showing two outlets. FIG. 19 shows how costs can be reduced and the design process simplified by using a larger transducer (1902), located behind the mobile screen (1903), having multiple outlets such as (1901). The larger transducer is typically easier to fabricate and can output more energy than a smaller transducer. This multi-purpose use of the transducers can significantly reduce the overall system cost and complexity.

FIG. 22 shows a screen with transmitters 2002 and receivers 2001 on opposite sides of the screen. This allows channels defined across the screen to be used which has been found to be particularly effective at solving hand/finger confusion problems when locating the position of the finger 2003 relative to the screen for tracking purposes.

The features of the various embodiments of the inventions disclosed herein can be combined in any number of ways. As a non-limiting example, one can combine the directionality and the use of the inverse filters of the transducers with their placement such as to avoid overlapping between echoes from the finger and the hand. For some positioning of the finger and hand relative to the transducers, such overlap could be avoided altogether, whereas for others, the directivity and subsequent inverse filtering of the signals could be used to separate the echoes of the finger from the echoes from the hand. Furthermore, both these modes of inventions could, in addition to providing touchless interaction improvement in their own rights or in combinations with one another, be used to aid other touchless interaction systems such as camera system or projected light system, which might need a secondary source of positioning information in order to accurately locate, track and recognize the shape of the tracked object.

1.-97. (canceled)

98. Apparatus for determining the position of a target part of a user's hand within a predetermined zone, the apparatus comprising a plurality of transducers for transmitting or receiving, or both transmitting and receiving, locating signals; wherein the transducers are arranged such that, for any location of the target hand part within the predetermined zone there are at least two pairings of transmitting transducers and receiving transducers for which the total time-of-flight of said locating signals from the transmitter of the pairing to the receiver of the pairing via the target part of the user's hand is less than the equivalent total times-of-flight to and from a set of points, wherein said set of points comprises all points in the predetermined zone which are beyond a minimum spacing from the target hand part but at least as far away from the nearest point of the apparatus as the location of the target hand part is.

99. The apparatus of claim 98 comprising at least three pairings of transmitting transducers and receiving transducers for which the total time-of-flight of said locating signals from the transmitter of the pairing to the receiver of the pairing via the target part of the user's hand is less than equivalent total times-of-flight to and from said set of points.

100. The apparatus of claim 98 wherein the target part of the user's hand is an extended digit.

101. The apparatus of claim 98 wherein at least one transducer is a transmitter and/or receiver for more than one transmitter-receiver pairing.

102. The apparatus of claim 98 wherein the transducers are ultrasonic transducers.

103. The apparatus of claim 98 wherein the transmitting transducer or transducers are arranged to transmit ultrasonic signals at a frequency greater than 20 kHz.

104. The apparatus of claim 98 comprising logic configured to determine information relating to the time of flight of the signal for each pairing.

105. The apparatus of claim 98 configured to select one or more transmitter-receiver pairings to use for positional measurements.

106. The apparatus of claim 98 configured to compare results obtained from each transmitter-receiver pairing and to select a subset of the results for further processing.

107. The apparatus of claim 106 configured to determine whether a transmitter-receiver pair provides a predetermined distinction between said object and an interfering reflector.

108. The apparatus of claim 106 comprising logic arranged to calculate impulse responses for at least some of the transmitter-receiver pairings and select a transmitter-receiver pairing based on the extent to which, for a given pairing, a part of the impulse response for corresponding to said object can be distinguished from the rest of the impulse response for that pairing.

109. The apparatus of claim 106 configured to select a transmitter-receiver pairing if the total time-of-flight of signals from the transmitter of the pairing to the receiver of the pairing via the object is less than the equivalent total times-of-flight to and from said set of points.

110. The apparatus of claim 98 comprising logic arranged to calculate impulse responses from each transmitter-receiver pairing and decide which pairings to use for determining the position of a target part of the user's hand on the basis of which impulse response or responses give the best separation between the impulse response corresponding to the target part of the hand and the impulse response corresponding to the rest of the hand.

111. The apparatus of claim 98 comprising logic arranged to associate two peaks or signal fronts of an impulse response from a transmitter-receiver pairing with a target part and another part of the user's hand respectively and, when said association is made, to select this pairing as having an unobstructed view of the target part.

112. The apparatus of claim 98 configured to provide feedback to a user that a predetermined number of transmitter-receiver pairings have a clear view of an object to be tracked.

113. The apparatus of claim 112 wherein a pairing is determined to have a clear view of the object to be tracked if the signal from the receiver of the pairing meets a predetermined criterion for distinguishing a target hand part or other object from the rest of the hand or other potentially interfering reflector.

114. The apparatus of claim 112 wherein a pairing is determined to have a clear view of the object to be tracked if the total time-of-flight of signals from the transmitter of the pairing to the receiver of the pairing via the object is less than the equivalent total times-of-flight to and from a set of points, wherein said set of points comprises all points in a predetermined zone and which are beyond a minimum spacing from the object but at least as far away from the nearest point of the apparatus as the object is.

115. The apparatus of claim 98 comprising a plurality of receivers and at least one analogue-to-digital converter arranged such that the converter can selectively receive signals from two or more of said receivers.

116. The apparatus of claim 98 comprising a plurality of transmitters and at least one digital-to-analogue converter arranged such that the converter can selectively pass signals to two or more of said transmitters.

117. The apparatus of claim 116 arranged to determine according to a fixed schedule to which transmitter the digital-to-analogue converter passes signals.

118. The apparatus of claim 116 arranged adaptively to determine to which transmitter the digital-to-analogue converter passes signals.

119. The apparatus of claim 98 comprising a display screen and adapted to track the movements of the target hand part in order to control the movement of a selection indicator on said display screen.

120. The apparatus of claim 98 wherein the predetermined zone in which movements of the hand part can be tracked includes at least part of the area of a display screen.

121. The apparatus of claim 120 wherein said predetermined zone extends beyond at least one edge of the display screen.

122. The apparatus of claim 98 comprising a control surface having at least four transducers arranged around the periphery, said transducers comprising at least one transmitter and at least one receiver, thereby defining at least three transmitter receiver-pairings, wherein said transducers are arranged such that the separation between the respective transmitter and receiver of each pairing is at least a quarter of the length of the shortest side of the control surface.

123. The apparatus of claim 98 comprising at least one inverting filter arranged to be applied to a signal to be transmitted by a transmitter or a signal received by a receiver, said inverting filter compensating for the directional pattern of said transmitter or receiver.

124. The apparatus of claim 98 wherein at least one of the transducers or its housing is configured to enhance the directivity of the transducer.

125. The apparatus of claim 124 comprising: a scattering structure arranged such that a signal transmitted by the transmitter or reflection received by the receiver passes through it and configured in use to modify the signal or reflection as a function of propagation direction; and logic for digitally analysing the received signal to determine a bearing to said object.

126. Apparatus for determining the position of a target part of a user's hand comprising: a plurality of transmitter-receiver pairs, means for determining which of said transmitter-receiver pairs is able to meet a predetermined criterion for determining a distance to the target part, and means for providing feedback to the user that the apparatus is capable of tracking the target part depending upon the number of transmitter-receiver pairs meeting said criterion.

127. Apparatus for tracking an object comprising a control surface having at least four transducers arranged around the periphery, said transducers comprising at least one transmitter and at least one receiver, thereby defining at least three transmitter receiver pairings, wherein said transducers are arranged such that the separation between the respective transmitter and receiver of each pairing is at least a quarter of the length of the shortest side of the control surface.

128. The apparatus of claim 127 wherein said shortest side is at least 5 cm.

129. The apparatus of claim 127 wherein the separation between the respective transmitter and receiver of each pairing is at least half the length of said shortest side of the control surface.

130. The apparatus of claim 127 wherein the transducers comprise one transducer of one type and three transducers of the opposite type.

131. The apparatus of claim 127 wherein said transducers are not all on the same side of the control surface and at least two transducers of the same type are on the same side as one another and are separated by at least an amount equal to 10% of the length of the shortest sides of the control surface.

132. Apparatus for determining the position of a target part of a user's hand within a predetermined zone, the apparatus comprising a plurality of transducers for transmitting or receiving, or both transmitting and receiving, locating signals; wherein the transducers are arranged such that, whenever the target hand part is the closest part of the hand to an predetermined edge of the zone, then for at least one transmitter-receiver pair, the maximum time of flight of a locating signal transmitted by the transmitter, reflected by said target part of the hand and received by the receiver, is shorter by at least a threshold time than the minimum time of flight of a locating signal reflected by parts of the hand which are more than a predetermined distance away from the target part of the hand.

133. The apparatus of claim 132 wherein said threshold time is equal to one divided by the product of the bandwidth of the apparatus and the sampling frequency of the apparatus.

134. Apparatus for tracking movement of an object comprising a plurality of transducers defining between them a plurality of channels, each comprising a transmitter and a receiver, and processing means for selecting a subset of said channels for calculating said movement.

135. The apparatus of claim 134 comprising logic configured to measure the time of flight of a signal travelling from the transmitter and being reflected from the object to the receiver.

136. The apparatus of claim 134 configured to determine whether a channel provides a predetermined distinction between said object and an interfering reflector.

137. The apparatus of claim 134 comprising logic arranged to calculate impulse responses for at least some of the channels and select a channel based on the extent to which, for a given channel, a part of the impulse response for corresponding to said object can be distinguished from the rest of the impulse response for that channel.

138. The apparatus of claim 134 configured to select a channel if the total time-of-flight of signals from the transmitter of the channel to the receiver of the channel via the object is less than the equivalent total times-of-flight to and from a set of points, wherein said set of points comprises all points in a predetermined zone and which are beyond a minimum spacing from the object but at least as far away from the nearest point of the apparatus as the object is.

139. The apparatus of claim 134 comprising logic arranged to calculate impulse responses from each channel and decide which channel to use for determining the position of a target part of the user's hand on the basis of which impulse response or responses give the best separation between the impulse response corresponding to the target part of the hand and the impulse response corresponding to the rest of the hand.

140. The apparatus of claim 134 comprising logic arranged to associate two peaks or signal fronts of an impulse response from a channel with a target part and another part of the user's hand respectively and, when said association is made, to select this channel as having an unobstructed view of the target part.

141. The apparatus of claim 134 configured to provide feedback to a user that a predetermined number of channels have a clear view of an object to be tracked.

142. The apparatus of claim 141 wherein a channel is determined to have a clear view of the object to be tracked if the signal from the receiver of the channel meets a predetermined criterion for distinguishing a target hand part or other object from the rest of the hand or other potentially interfering reflector.

143. The apparatus of claim 141 wherein a channel is determined to have a clear view of the object to be tracked if the total time-of-flight of signals from the transmitter of the channel to the receiver of the channel via the object is less than the equivalent total times-of-flight to and from a set of points, wherein said set of points comprises all points in a predetermined zone and which are beyond a minimum spacing from the object but at least as far away from the nearest point of the apparatus as the object is.

144. A method of tracking movement of an object comprising using a plurality of transducers defining between them a plurality of channels, each comprising a transmitter and a receiver, and selecting a subset of said channels for calculating said movement.

145. The method of claim 144 comprising modifying the frequency spectrum of the transmitted signal to enhance or suppress frequencies corresponding to certain propagation directions.

146. The method of claim 144 comprising measuring the time of flight of a signal travelling from the transmitter and being reflected from the object to the receiver.

147. The method of claim 144 comprising determining whether a channel provides a predetermined distinction between said object and an interfering reflector.

148. The method of claim 144 comprising calculating impulse responses for at least some of the channels and selecting a channel based on the extent to which a part of the impulse response for a given channel corresponding to said object can be distinguished from the rest of the impulse response for that channel.

149. The method of claim 144 comprising selecting a channel if the total time-of-flight of signals from the transmitter of the channel to the receiver of the channel via the object is less than the equivalent total times-of-flight to and from a set of points, wherein said set of points comprises all points in a predetermined zone and which are beyond a minimum spacing from the object but at least as far away from the nearest point of an apparatus incorporating the transmitter and receiver, as the object is.

150. The method of claim 144 comprising calculating impulse responses from each transmitter-receiver channel and deciding which channels to use for determining the position of a target part of the user's hand on the basis of which impulse response or responses give the best separation between the impulse response corresponding to the target part of the hand and the impulse response corresponding to the rest of the hand.

151. The method of claim 144 comprising associating two peaks or signal fronts of an impulse response image from a transmitter-receiver channel with a target part and another part of the user's hand respectively and, when said association is made, selecting this pair as having an unobstructed view of the target part.

152. The method of claim 144 comprising providing feedback to a user that a predetermined number of transmitter-receiver channels have a clear view of an object to be tracked.

153. The method of claim 152 wherein a channel is determined to have a clear view of the object to be tracked if the signal from the receiver of the channel meets a predetermined criterion for distinguishing a target hand part or other object from the rest of the hand or other potentially interfering reflector.

154. The method of claim 152 wherein a channel is determined to have a clear view of the object to be tracked if the total time-of-flight of signals from the transmitter of the channel to the receiver of the channel via the object is less than the equivalent total times-of-flight to and from a set of points, wherein said set of points comprises all points in a predetermined zone and which are beyond a minimum spacing from the object but at least as far away from the nearest point of an apparatus incorporating the transmitter and receiver, as the object is.

155. A method of determining the position of a target part of a user's hand comprising: determining which of a plurality of transmitter-receiver pairs is able to meet a predetermined criterion for determining a distance to the target part, and feeding back to a user that the apparatus is capable of tracking the target part depending upon the number of transmitter-receiver pairs meeting said criterion.
